(19) United States
(12) Patent Application Publication
(10) Pub. No.: US 2026/0040241 A1
(43) Pub. Date: Feb. 5, 2026

(54) Managing Multiple Timing Advance Values for Multiple Transmit and/or Receive Points

(71) Applicant: GOOGLE LLC, Mountain View, CA (US)

(72) Inventors: Chih-Hsiang Wu, Taoyuan City (TW); Jia-Hong Liou, Mountain View, CA (US)

(21) Appl. No.: 19/099,736

(22) PCT Filed: Jul. 29, 2023
(86) PCT No.: PCT/US2023/029054

§ 371 Date: Jan. 29, 2025

Related U.S. Application Data
(60) Provisional application No. 63/393,818, filed on Jul. 29, 2022.
(60) Provisional application No. 63/393,591, filed on Jul. 29, 2022.

(51) Int. Cl. H04W 56/00; H04L 5/00; H04W 72/231

(52) U.S. Cl. CPC H04W 56/001; H04L 5/0035; H04W 72/231

(57) ABSTRACT

To managing synchronization, radio access network (RAN) node transmits, to a user equipment (UE), a first timing advance (TA) value for managing synchronization of first transmissions between the UE and a first transmission and reception point (TRP) of the RAN node (606); transmits, to the UE, a second TA value for managing synchronization of second transmissions between the UE and a second TRP of the RAN node (608); stops scheduling the first transmissions in response to determining that the synchronization of the first transmissions is invalid (612); and stops scheduling the second transmissions in response to determining that the synchronization of the second transmissions is invalid (614).

### CROSS-REFERENCE TO RELATED APPLICATIONS

This application claims priority to and the benefit of the filing date of provisional U.S. Patent Application No. 63/393,818 entitled “MAINTAINING A TA VALUE IN A MULTIPLE-TRP SCENARIO IN A WIRELESS COMMUNICATION SYSTEM,” filed on Jul. 29, 2022 and provisional U.S. Patent Application No. 63/393,591 entitled “MANAGING MULTIPLE TIMING ADVANCE VALUES FOR MULTIPLE TRANSMIT AND/OR RECEIVE POINTS,” filed on Jul. 29, 2022. The entire contents of the provisional application are hereby expressly incorporated herein by reference.

### FIELD OF THE DISCLOSURE

This disclosure relates generally to wireless communications and, more particularly, to managing multiple timing advance values for communication over multiple transmit and/or receive points (TRPs) between a user equipment (UE) and a base station.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

Presently, techniques exist to support multiple-TRP (mTRP) operation for physical downlink shared channel (PDSCH), physical downlink control channel (PDCCH), physical uplink shared channel (PUSCH), and physical uplink control channel (PUCCH) transmissions, In particular, a maximum of two TRPs are currently supported in mTRP operation(s).

Moreover, mTRP PDSCH transmission is currently supported with two different mechanisms: single-downlink control information (DCI) and multiple DCI (multi-DCI). Further, mTRP PDSCH transmission is extended to inter-cell operation. In inter-cell operation, a UE can be configured by a gNB with a synchronization signal block (SSB) associated with a physical cell identity (PCI) which is different from a PCI of serving cell, known as an additional PCI. At most, seven different additional PCIs can be configured by the gNB to the UE, and only one of the additional PCIs is activated for inter-cell mTRP operation. The additional PCI can be associated with one or more Transmission Configuration Indication (TCI) states, and the gNB can schedule PDSCH transmissions dynamically from either TRP by indicating a TCI and/or indicating a particular TCI state in a DCI. Moreover, mTRP PDCCH transmission, PUSCH transmission, and PUCCH transmission are supported for both intra-cell operation and inter-cell operation.

In mTRP operation, the gNB ensures that transmissions from/to two TRPs are synchronized for UEs in different locations within the coverage of the two TRPs connected to the gNB. In some deployment scenarios (e.g., the two TRPs belong to different cells or the distance between the two TRPs is large), the gNB is not be able to ensure that transmissions from/to the two TRPs always synchronized for UEs in different locations within the coverage of the two TRPs. Therefore, to enable mTRP operation, the UE and gNB maintain two uplink synchronizations for communications between the UE and two TRPs. However, it is not clear how the gNB manages scenarios where one of the two uplink synchronizations is no longer valid.

### SUMMARY

An example embodiment of these techniques is a method for managing synchronization, the method implemented in a radio access network (RAN) node and comprising: transmitting, to a user equipment (UE), a first timing advance (TA) value for managing synchronization of first transmissions between the UE and a first transmission and reception point (TRP) of the RAN node; transmitting, to the UE, a second TA value for managing synchronization of second transmissions between the UE and a second TRP of the RAN node; stopping scheduling the first transmissions in response to determining that the synchronization of the first transmissions is invalid; and stopping scheduling the second transmissions in response to determining that the synchronization of the second transmissions is invalid.

Another example embodiment of these techniques is a radio access network (RAN) comprising a transceiver; and processing hardware configured to implement a method according to any of the preceding claims.

### BRIEF DESCRIPTION OF THE DRAWINGS

FIG. 1A is a block diagram of an example wireless communication system in which a radio access network (RAN) and/or a user equipment (UE) can implement the techniques of this disclosure;

FIG. 1B is a block diagram of an example base station, including a central unit (CU) and a distributed unit (DU), that can operate in the RAN of FIG. 1A;

FIGS. 2A is a block diagram of an example protocol stack according to which the UE of FIG. 1A can communicate with the RAN of FIG. 1A;

FIG. 2B is a block diagram of an example protocol stack according to which the UE of FIG. 1A can communicate with a DU and a CU of a base station of FIG. 1A or 1B;

FIG. 3A is a block diagram of a detailed structure of various sublayers of a protocol stack as depicted in FIGS. 2A and/or 2B, including a scheduling and/or priority handling function;

FIG. 3B is a block diagram of a detailed structure of various sublayers of a protocol stack, similar to FIG. 3A, but in which the structure includes a logical channel prioritization function;

FIG. 4A is a block diagram of a HARQ entity including a plurality of HARQ processes and communicating with a transport channel to a plurality of TRPs;

FIG. 4B is a block diagram of a HARQ entity similar to that of FIG. 4A, but in which the HARQ entity includes a plurality of HARQ process groups associated with a plurality of transport channels to a plurality of TRPs;

FIG. 4C is a block diagram of a HARQ entity similar to that of FIG. 4A, but in which the HARQ entity communicates with a single TRP;

FIG. 5A is a messaging diagram of an example scenario in which a UE synchronizes with a first TRP and/or a second TRP for performing communications with a base station;

FIG. 5B is a messaging diagram of an example scenario similar to FIG. 5A, but in which the UE receives UL and DL configuration parameters in separate radio resource configuration messages;

FIG. 5C is a messaging diagram of an example scenario similar to FIG. 5A, but in which the base station transmits the UL configuration parameters to the UE via the second TRP rather than the first TRP;

FIG. 5D is a messaging diagram of an example scenario similar to FIG. 5A, but in which the UE receives a response from the base station while performing a random access procedure via the first TRP rather than via the second TRP;

FIG. 5E is a messaging diagram of an example scenario similar to FIG. 5A, but in which the UE receives the PDCCH order via the first TRP rather than the second TRP;

FIG. 6 is a flow diagram of an example method in which a RAN node of FIGS. 1A and/or 1B determines whether to stop scheduling the UE to transmit UL transmissions to the first or second TRP based on whether the first or second UL synchronization is invalid;

FIG. 7A is a flow diagram of an example method similar to FIG. 6, but in which the determination is whether to flush HARQ buffers of a first or second set of HARQ processes for the first or second TRP;

FIG. 7B is a flow diagram of an example method similar to FIG. 7A, but in which the determination is whether to flush HARQ buffers of processes for the first and second TRP based on whether the first and second UL synchronization are invalid;

FIG. 8A is a flow diagram of an example method similar to FIG. 6, but in which the determination is whether to clear configured grants associated with the first or second TRP;

FIG. 8B is a flow diagram of an example method similar to FIG. 8A, but in which the determination is whether to clear configured grants associated with the first and second TRP based on whether the first and second UL synchronization are invalid;

FIG. 9A is a flow diagram of an example method similar to FIG. 6, but in which the determination is whether to release PUCCH CSI resources and/or scheduling request resource configuration instances associated with the first or second TRP;

FIG. 9B is a flow diagram of an example method similar to FIG. 9A, but in which the determination is whether to release PUCCH CSI resources and/or scheduling request resource configuration instances associated with the first and second TRP based on whether the first and second UL synchronization are invalid;

FIG. 10A is a flow diagram of an example method similar to FIG. 6, but in which the determination is whether to release SRS resource configuration instances associated with the first or second TRP;

FIG. 10B is a flow diagram of an example method similar to FIG. 10A, but in which the determination is whether to release SRS resource configuration instances associated with the first and second TRP based on whether the first and second UL synchronization are invalid;

FIG. 11A is a flow diagram of an example method similar to FIG. 6, but in which the determination is whether to clear PUSCH resources for CSI reporting associated with the first or second TRP;

FIG. 11B is a flow diagram of an example method similar to FIG. 11A, but in which the determination is whether to clear PUSCH resources for CSI reporting associated with the first and second TRP based on whether the first and second UL synchronization are invalid;

FIG. 12 is a flow diagram of an example method similar to FIG. 6, but in which the determination is whether to transmit a random access triggering command for the first or second TRP;

FIG. 13 is a flow diagram of an example method in which a RAN node of FIGS. 1A and/or 1B determines whether a first or second UL synchronization is invalid based on whether a first or second TAT expires;

FIG. 14 is a flow diagram of an example method similar to FIG. 13, but in which the determination is based on whether an indication indicates that the first or second UL synchronization is invalid; and

FIG. 15 is a flow diagram of an example method in which a RAN node of FIGS. 1A and/or 1B transmits a first and second TA value for a first and second UL synchronization and subsequently maintains the first and second UL synchronization with the UE.

### DETAILED DESCRIPTION OF THE DRAWINGS

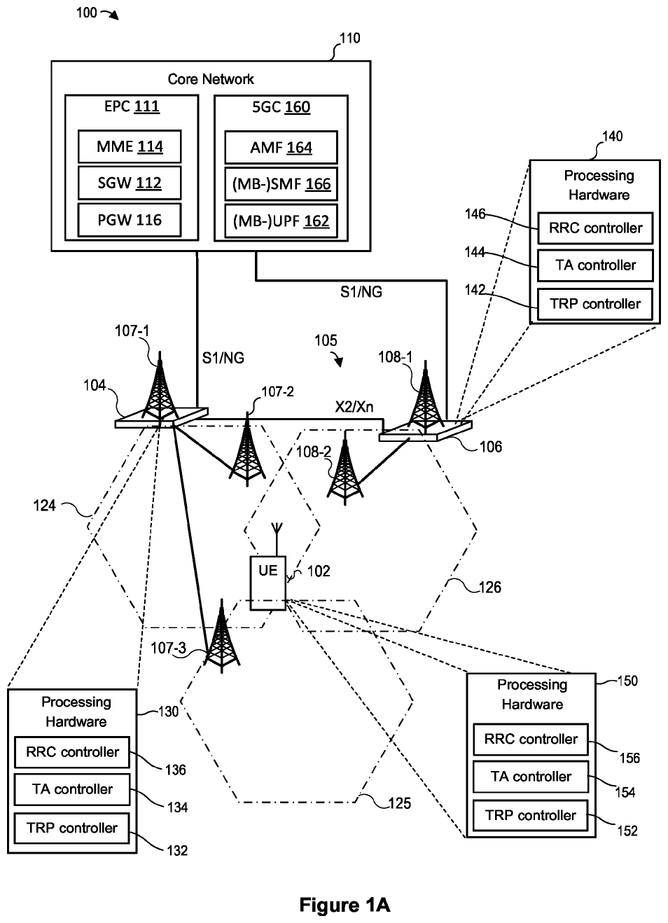

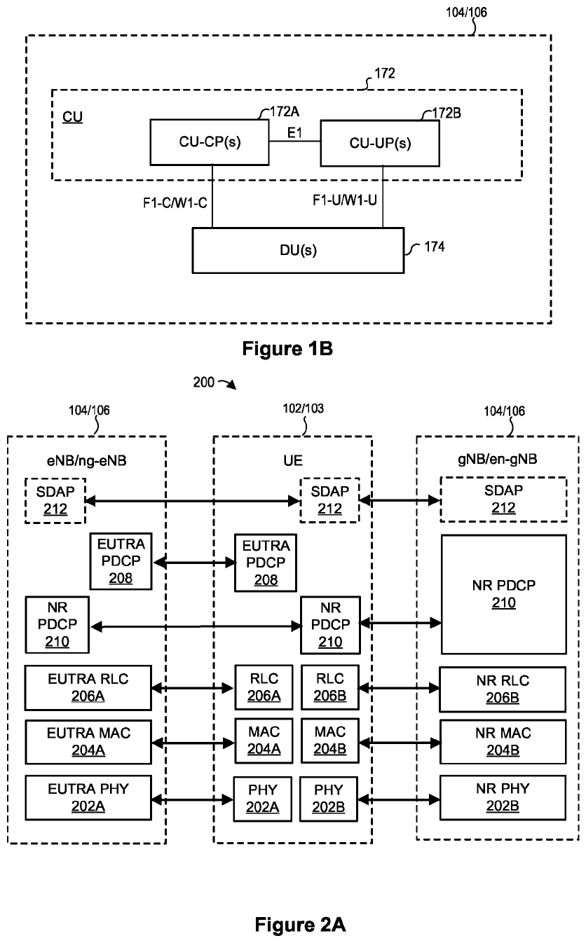

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 can cover one or more cells (e.g., cells 124 and 125) with one or more transmit and/or receive points (TRPs), and the base station 106 can similarly cover one or more cells (e.g., cell 126) with one or more TRPs. For example, the base station 104 operates cell 124 with TRPs 107-1 and 107-2 and operates cell 125 with TRP 107-3, and the base station 106 operates cell 126 with TRPs 108-1 and 108-2. The cells 124 and 125 are operated on the same carrier frequency/frequencies. The cell 126 can be operated on the same carrier frequency/frequencies as the cells 124 and 125. Alternatively, the cell 126 can be operated on different carrier frequency/frequencies from the cells 124 and 125. In some implementations, the base station 104 connects each of the TRPs 107-1, 107-2 and 107-3 via a fiber connection or an Ethernet connection. If the base station 104 is a gNB, the cells 124 and 125 are NR cells. If the base station 104 is an (ng-)eNB, the cells 124 and 125 are evolved universal terrestrial radio access (EUTRA) cells. Similarly, if the base station 106 is a gNB, the cell 126 is an NR cell, and if the base station 106 is an (ng-)eNB, the cell 126 is an EUTRA cell. The cells 124, 125, and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base station 104 via the TRP 107-1, TRP 107-2 and/or TRP-3. Similarly, the UE 102 can support at least a 5G NR (or simply, “NR”) or E-UTRA air interface to communicate with the base station 106 via the TRP 108-1 and/or TRP 108-2. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

When a base station (e.g., the base station 104 or 106) transmits DL data via a TRP (e.g., the TRP 107-1, TRP 107-2, TRP 107-3, TRP 108-1 or TRP 108-2), the base station 104 can generate a packet including the data transmit the packet to the TRP 107-1. For example, the packet can be a fronthaul transport protocol data unit. The TRP extracts the data from the packet and transmits the data. In some implementations, the base station 104 can include control information for time-critical control and management information directly related to the data in the packet, and the TRP can transmit the data in accordance with the control information. In some implementations, the data includes In-phase and Quadrature (IQ) data, a physical layer bit sequence, or a MAC PDU. When the TRP receives data from a UE (e.g., UE 102), the TRP generates a packet including the data and transmit the packet to the base station 104. In some implementations, the data includes IQ data, a physical layer bit sequence, or a MAC PDU.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE 102 to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports cells 124 and 125, and the base station 106 supports a cell 126. The cells 124, 125, and 126 can partially overlap, so that the UE 102 can select, reselect, or hand over from one of the cells 124, 125, and 126 to another. To directly exchange messages or information, the base station 104 and base station 106 can support an X2 or Xn interface. In general, the CN 110 can connect to any suitable number of base stations supporting NR cells and/or EUTRA cells.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller 132 configured to transmit data and control signal on physical DL channels and DL reference signals with one or more user devices (e.g., UE 102) via one or more TRPs (e.g., TRP 107-1, TRP 107-2 and/or TRP 107-3). The PHY controller 132 is also configured to receive data and control signal on physical UL channels and/or UL reference signals with the one or more user devices via the one or more TRPs (e.g., TRP 107-1, TRP 107-2 and/or TRP 107-3). The processing hardware 130 in an example implementation includes a MAC controller 134 configured to perform a random access (RA) procedure with one or more user devices, manage UL timing advance for the one or more user devices, receive UL MAC PDUs from the one or more user devices, and transmit DL MAC PDUs to the one or more user devices. The processing hardware 130 can further include an RRC controller 136 to implement procedures and messaging at the RRC sublayer of the protocol communication stack. The base station 106 can include processing hardware 140 that is similar to processing hardware 130. In particular, components 142, 144, and 146 can be similar to the components 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more TRPs (e.g., TRP 107-1, TRP 107-2, TRP 107-3, TRP 108-1 and/or TRP 108-2). The PHY controller 152 is also configured to transmit data and control signal on physical UL channels and/or UL reference signals with the base station 104 or 106 via the one or more TRPs (e.g., TRP 107-1, TRP 107-2, TRP 107-3, TRP 108-1 and/or TRP 108-2). The processing hardware 150 in an example implementation includes a MAC controller 154 configured to perform a random access procedure with base station 104 or 106, manage UL timing advance for the one or more user devices, transmit UL MAC PDUs to the base station 104 or 106, and receive DL MAC PDUs from the base station 104 or 106. The processing hardware 150 can further include an RRC controller 156 to implement procedures and messaging at the RRC sublayer of the protocol communication stack.

FIG. 1B depicts an example distributed or disaggregated implementation of one or both of the base stations 104, 106. In this implementation, each of the base station 104 and/or 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller (e.g., PDCP controller 134, 144), an RRC controller (e.g., RRC controller 136, 146), and/or an RRC inactive controller (e.g., RRC inactive controller 138, 148). In some implementations, the CU 172 can include an RLC controller configured to manage or control one or more RLC operations or procedures. In other implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The processing hardware can also include a physical layer controller configured to manage or control one or more physical layer operations or procedures.

In some implementations, the RAN 105 supports Integrated Access and Backhaul (IAB) functionality. In some implementations, the DU 174 operates as an (IAB)-node, and the CU 172 operates as an IAB-donor.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or SDAP protocol of the CU 172. The CU-CP 172A can transmit control information (e.g., RRC messages, F1 application protocol messages), and the CU-UP 172B can transmit data packets (e.g., SDAP PDUs or IP packets).

The CU-CP 172A can be connected to multiple CU-UPs 172B through the E1 interface. The CU-CP 172A selects the appropriate CU-UP 172B for the requested services for the UE 102. In some implementations, a single CU-UP 172B can be connected to multiple CU-CPs 172A through the E1 interface. If the CU-CP 172A and DU(s) 174 belong to a gNB, the CU-CP 172A can be connected to one or more DU 174s through an F1-C interface and/or an F1-U interface. If the CU-CP 172A and DU(s) 174 belong to an ng-eNB, the CU-CP 172A can be connected to DU(s) 174 through a W1-C interface and/or a W1-U interface. In some implementations, one DU 174 can be connected to multiple CU-UPs 172B under the control of the same CU-CP 172A. In such implementations, the connectivity between a CU-UP 172B and a DU 174 is established by the CU-CP 172A using Bearer Context Management functions.

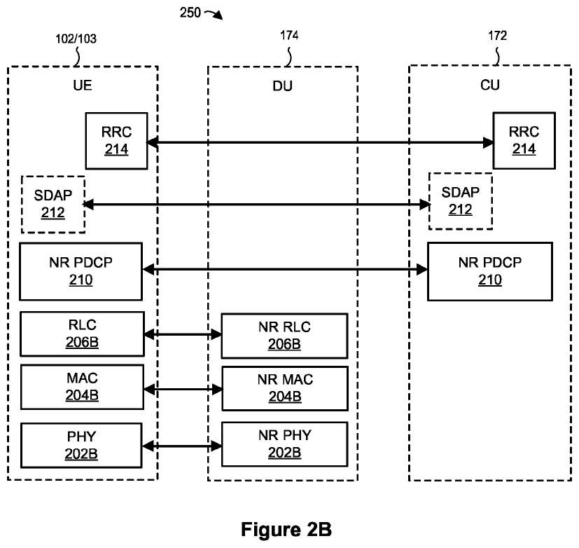

FIG. 2A illustrates, in a simplified manner, an example protocol stack 200 according to which the UE 102 can communicate with an eNB/ng-eNB or a gNB (e.g., one or both of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to the SDAP sublayer 212 or an RRC sublayer (not shown in FIG. 2A). The UE 102, in some implementations, supports both the EUTRA and the NR stack as shown in FIG. 2A, to support handover between EUTRA and NR base stations and/or to support dual connectivity (DC) over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an IP layer, layered directly or indirectly over the PDCP layer 208 or 210) that can be referred to as SDUs, and output packets (e.g., to the RLC layer 206A or 206B) that can be referred to as PDUs. Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) to the RRC sublayer (not shown in FIG. 2A) to exchange RRC messages or NAS messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, IP packets, or Ethernet packets.

Thus, it is possible to functionally split the radio protocol stack, as shown by the radio protocol stack 250 in FIG. 2B. The CU at one or both of the base stations 104, 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

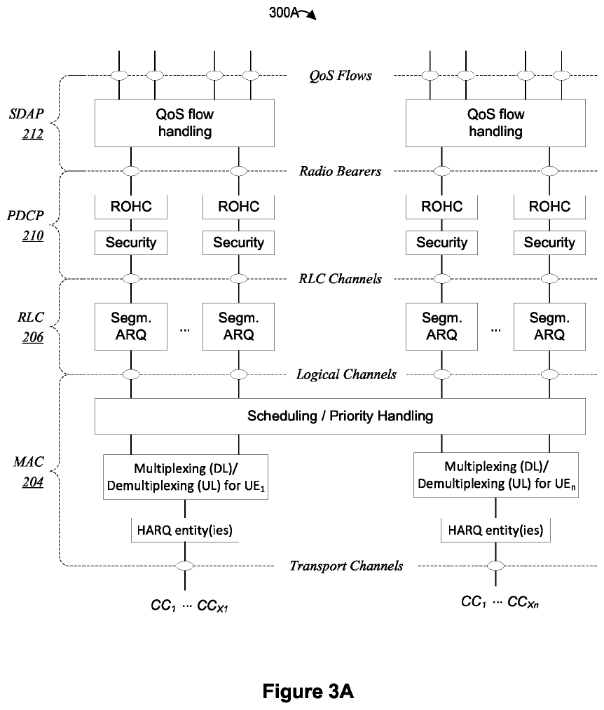

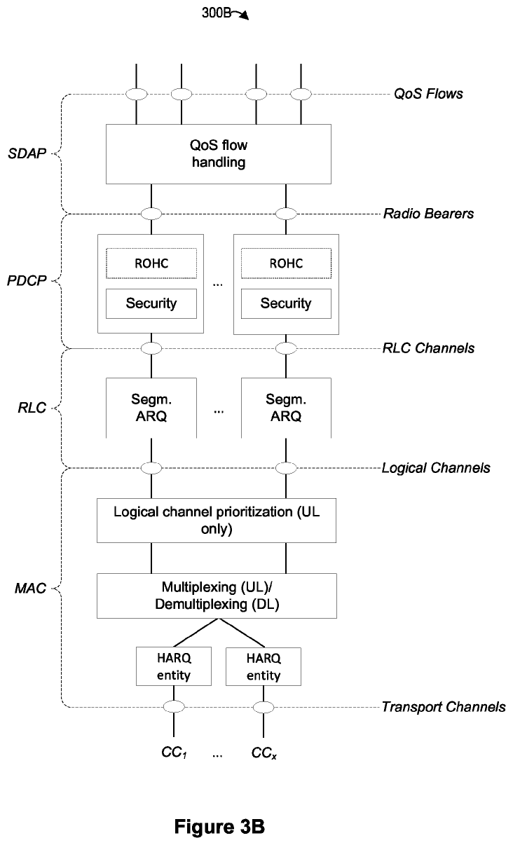

FIG. 3A illustrates a detailed structure 300A of the NR layer 2 protocol stack 200 or 250 for the base station 104 or 106. The PHY 202 (not shown in FIG. 3A) provides transport channels to the MAC sublayer 204. The MAC sublayer 204 includes a scheduling and/or priority handling function for scheduling and/or prioritizing DL and UL transmissions with one or more user devices. The MAC sublayer 204 also includes a multiplexing function for DL transmission and/or a demultiplexing function for UL transmission with a particular user device. The MAC sublayer 204 further includes Hybrid Automatic Repeat reQuest (HARQ) entities each for DL transmissions and/or UL transmissions on a particular DL component carrier (CC) and/or a particular UL CC with a particular user device. The RLC sublayer 206 includes segmentation and Automatic Repeat reQuest (ARQ) functions for DL data and UL data communicated with one or more UEs. The PDCP sublayer 210 provides radio bearers to the SDAP sublayer 212 and includes (i) security and (ii) robust header compression (ROHC) functions for (i) integrity protection and/or encryption/description and (ii) header compression/decompression, respectively. The SDAP sublayer 212 provides 5GC QoS flows to upper layer(s).

FIG. 3B illustrates a detailed structure 300B of the NR layer 2 protocol stack 200 or 250 for the UE 102, similar to structure 300A. The PHY 202 (not shown in FIG. 3B) provides, to the MAC sublayer 204, transport channels for DL and UL transmission with the base station(s) 104 or 106. The MAC sublayer 204 includes one or more HARQ entities each for DL transmissions and/or UL transmissions on a particular DL CC and/or a particular UL CC with the base station(s) 104 or 106. The MAC sublayer 204 also includes logical channel prioritization and multiplexing functions for UL transmission to the base station(s) 104 or 106 and includes a demultiplexing function for DL transmission from the base station(s) 104 or 106. The RLC sublayer 206 includes segmentation and Automatic Repeat reQuest (ARQ) functions for DL data and UL data communicated with the base station(s) 104 and/or 106. The PDCP sublayer 210 provides radio bearers to the SDAP sublayer 212 and includes (i) security and (ii) robust header compression (ROHC) functions for (i) integrity protection and/or encryption/description and (ii) header compression/decompression, respectively. The SDAP sublayer 212 provides 5GC QoS flows to upper layer(s).

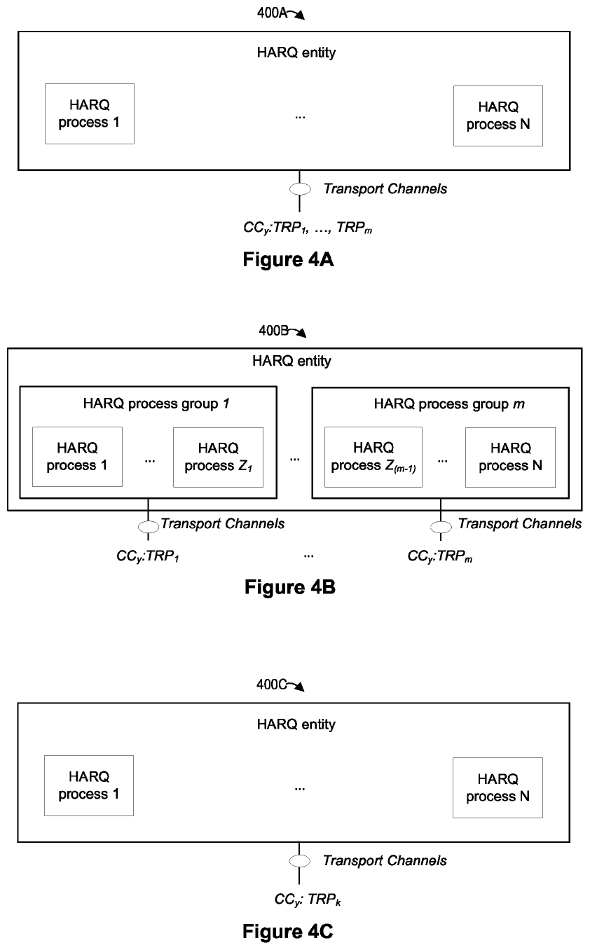

FIGS. 4A-4C illustrate different implementations of a HARQ entity for multiple TRP (mTRP) operation on a particular CC_{y} (e.g., UL CC or DL CC), which can be implemented in the UE 102, the base station 104 or 106, or the DU 174 of the base station 104 or 106.

Referring first to FIG. 4A which depicts a HARQ entity 400A. In some implementations, the HARQ entity 400A includes HARQ processes 1, . . . , N for communication with TPRs 1 . . . , m. N is an integer and larger than zero, and m is an integer and larger than zero. For example, N is 8, 16, 32, etc., and m is 2, 34, etc.

Next, FIG. 4B depicts further implementations of a HARQ entity 400B, similar to the HARQ entity 400A. The difference between the implementations of HARQ entities 400B and 400A is that the HARQ entity 400B partitions the HARQ processes 1, . . . , N into m groups, where each is used for communication with a particular TRP.

Next, FIG. 4C depicts an implementation of a HARQ entity 400C (e.g., HARQ entity k), similar to the HARQ entity 400A. The difference between the implementations of HARQ entities 400C and 400A is that the HARQ entity 400C is used for communication with a particular TRP (e.g., TRPₖ) on a particular CC (e.g., CCₖ), where 1<=k<=m. In other words, the UE 102 uses HARQ entity 1, . . . , m to communicate with a RAN node (e.g., the base station 104 or 106, or DU 174) via TRPs 1, . . . , m on each UL CC, respectively. Similarly, the RAN node uses HARQ entity 1, . . . , m to communicate with the UE 102 via TRPs 1, . . . , m of the RAN node (e.g., the base station 104 or 106, or DU 174) on each DL CC, respectively.

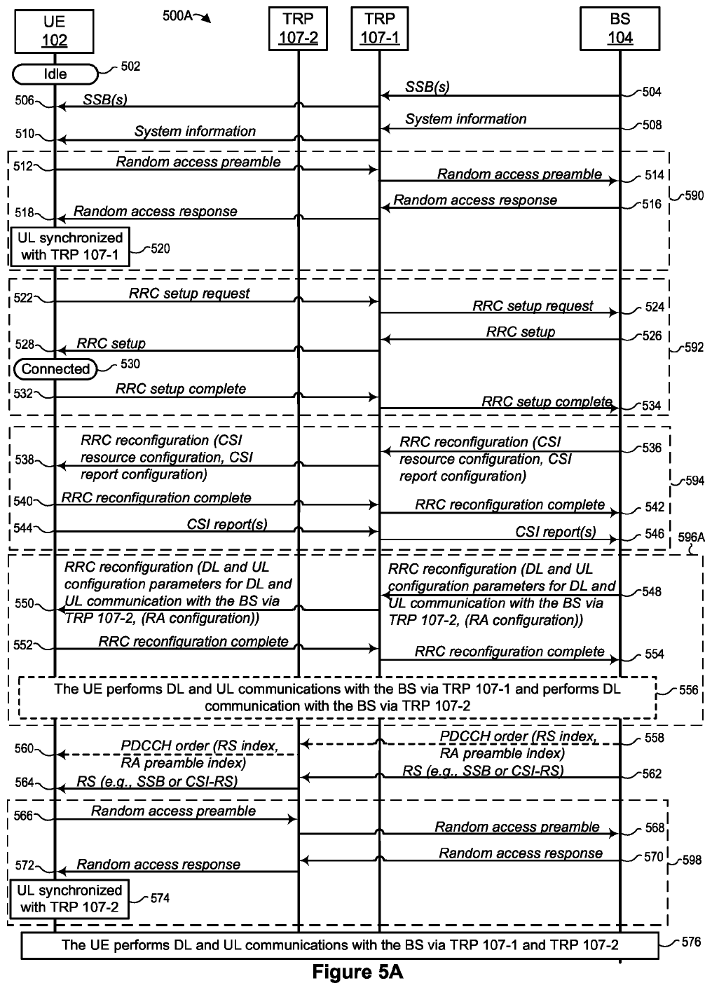

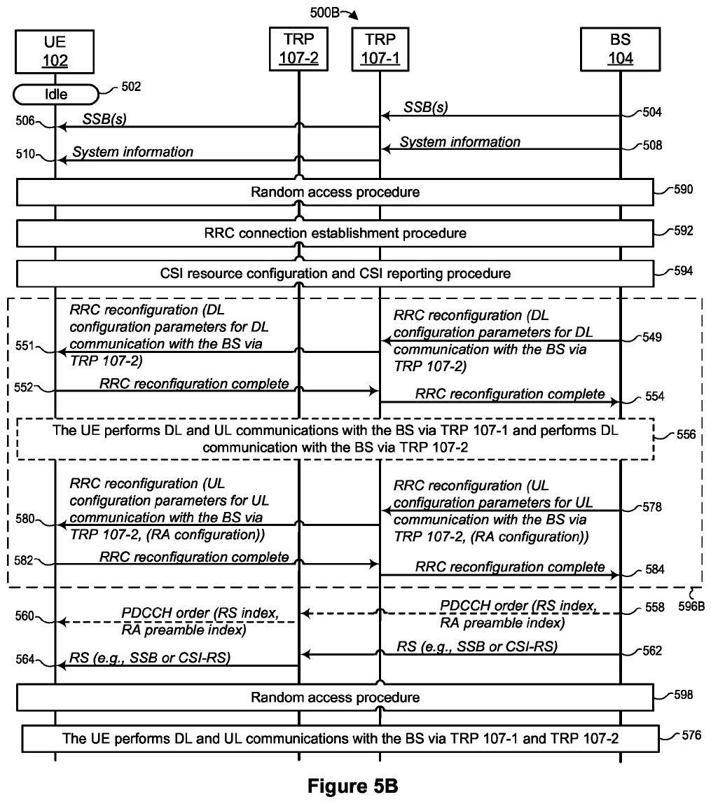

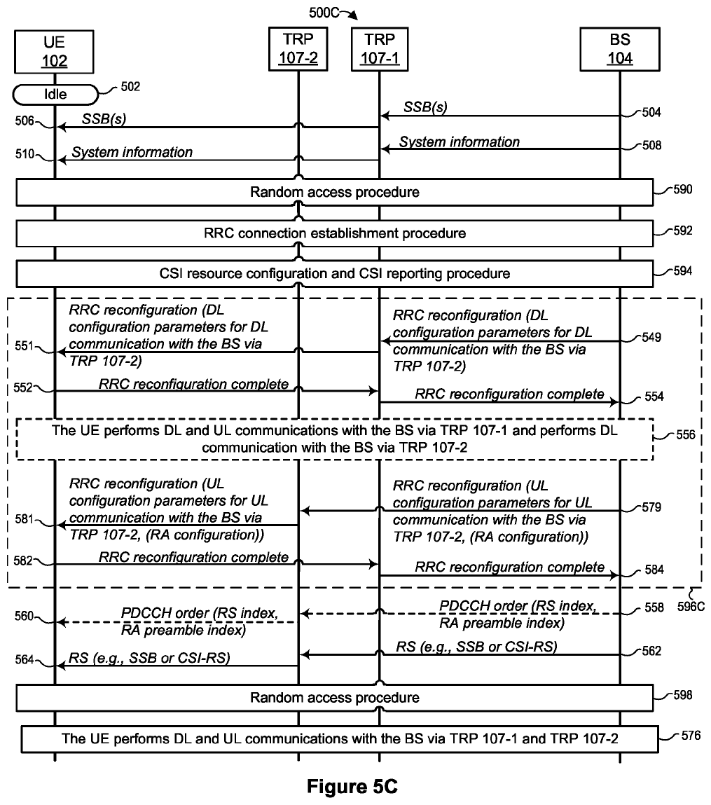

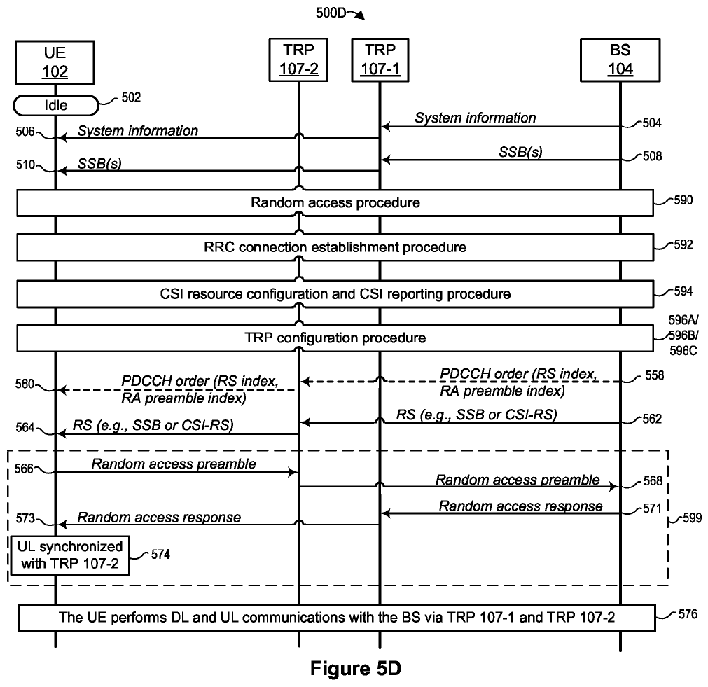

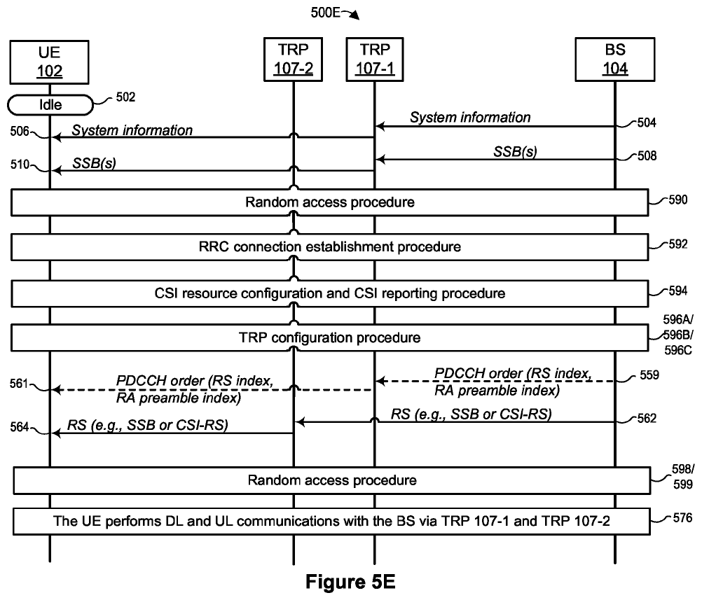

Next, several example scenarios that involve various components of FIG. 1A and relate to mTRP operation are discussed with reference to FIGS. 5A-5E. Generally, events in FIGS. 5A-5E that can be the same are labeled with the same reference numbers.

Referring first to FIG. 5A, in a scenario 500A, a base station 104 operates the cell 124, the TRP 107-1, and TRP 107-2. In the scenario 500A, the base station 104 broadcasts (e.g., periodically) 504, 506 one or more synchronization signal blocks (SSB(s)) and 508, 510 system information via the TRP 107-1. In some implementations, the system information includes master information block(s) (MIB) and/or system information block(s) (SIB(s)). In some examples, the SIB(s) include an SIB1 and further include an SIB2, SIB3, SIB4, and/or SIB5. The UE 102 initially operates 502 in an idle state (e.g., RRC_IDLE state). The UE 102 in the idle state receives 504, 506 the SSB(s) and 508, 510 the system information from the base station 104 via the TRP 107-1. In some implementations, the UE 102 detects that the base station 104 transmits the SSB(s) via the TRP 107-1. In some implementations, the UE 102 then uses one of the SSB(s) to perform downlink synchronization on the cell 124 with the base station 104 via the TRP 107-1, and receives 508, 510 the system information via the TRP 107-1 based on the SSB.

Later in time, the UE 102 determines to perform 590 a random access procedure to perform 592 an RRC connection establishment procedure. In response to the determination, the UE 102 transmits 512 a first random access preamble on a time/frequency resource and/or a random access channel (RACH) occasion to the TRP 107-1. The TRP 107-1 then forwards 514 the first random access preamble to the base station 104. In some implementations, the UE 102 selects an SSB from the SSB(s), for which an RSRP obtained by the UE 102 is above a first threshold (e.g., rsrp-ThresholdSSB), for the random access procedure. In other implementations, in cases where an RSRP for any SSB in the SSB(s) is not above the first threshold, the UE 102 selects an SSB from the SSB(s) and uses the SSB to determine the first random access preamble. In some such cases, the UE 102 selects the SSB from the SSB(s) randomly, or selects based on a UE-implementation. The UE 102 then determines the first random access preamble, time/frequency resource, and/or RACH occasion based on the selected SSB and random access configuration parameters included in the system information (e.g., the SIB1). In some implementations, the random access configuration parameters indicate one or more associations between (i) SSB(s) and (ii) random access preamble(s), RACH occasion(s), and/or time/frequency resource(s). Based on the selected SSB and the association(s), the UE 102 determines the first random access preamble, the RACH occasion, and/or time/frequency resource(s) to transmit the first random access preamble.

In response to the first random access preamble, the base station 104 transmits 516 a first random access response to the TRP 107-1. The TRP 107-1 then forwards 518 the first random access response to the UE 102. In some implementations, the base station 104 or TRP 107-1 identifies an SSB associated with the first random access preamble, RACH occasion, and/or time/frequency resource. In some cases where a single SSB is associated with the first random access preamble, RACH occasion, and/or time/frequency resource, the identified SSB is the SSB selected by the UE 102. In some cases where multiple SSBs are associated with the first random access preamble, RACH occasion, and/or time/frequency resource, the identified SSB is the same as or different from the SSB selected by the UE 102. In such implementations, the base station 104 transmits the first random access response to the UE 102 via the TRP 107-1, based on the identified SSB. The base station 104 includes a first preamble ID and a first TA command in the first random access response. The first preamble ID identifies the first random access preamble, and the first TA command includes a first TA value. The UE applies the first TA value and determines or maintains 520 an uplink that is synchronized (e.g., time aligned) with the TRP 107-1 after (e.g., in response to) applying the first TA value. The UE 102 applies the first TA value for transmitting UL transmissions (e.g., PUCCH transmissions, PUSCH transmissions, and/or sounding reference signal transmissions) until a new or different TA value is received from base station 104 that updates the first TA value. In some implementations, the UE 102 starts a first time alignment timer (TAT) to maintain a UL synchronization status with the TRP 107-1 or base station 104 after or upon receiving the first TA command. In some implementations, the base station 104 includes a UL grant (i.e., a RAR grant) in the random access response.

In some implementations, the base station 104 starts a first TAT to maintain a first UL synchronization for UL and/or DL communication with the UE 102 via the TRP 107-1 after transmitting the random access response or the first TA command to the UE 102. In some implementations, the TRP 107-1 generates timing information for or based on the first random access preamble received from the UE 102 and transmits the timing information to the base station 104. In some examples, the timing information indicates a propagation delay or a propagation delay shift. Based on the timing information received from the TRP 107-1, the base station 104 determines the first TA value.

The blocks 512, 514, 516, 518, and 520 are collectively referred to in FIG. 5A as a random access procedure 590.

During or after the random access procedure 590, the UE 102 transmits 522, 524 an RRC setup request message (e.g., RRCSetupRequest message) to the base station via the TRP 107-1. In some implementations, the UE 102 transmits the RRC setup request message using the UL grant received in the random access response. In response to the RRC setup request message, the base station 104 transmits 526, 528 an RRC setup message (e.g., RRCSetup message) to the UE 102 via the TRP 107-1. In some implementations, the base station 104 transmits a MAC PDU including contention resolution (e.g., MAC control element (CE)) to the UE 102 to resolve a contention for the random access procedure. In some implementations, the base station 104 includes the RRC setup message in the MAC PDU. In further implementations, after transmitting the MAC PDU, the base station 104 transmits another MAC PDU, including the RRC setup message, to the UE 102. In response to the RRC setup message, the UE 102 transitions 530 to a connected state (e.g., RRC_CONNECTED) and transmits 532, 534 an RRC setup complete message (e.g., RRCSetupComplete message) to the base station 104 via the TRP 107-1. In some implementations, after performing the RRC connection establishment procedure with the UE 102, the base station 104 performs a security activation procedure with the UE 102 to activate security protection (e.g., integrity protection/integrity check and encryption/decryption) for UL data and DL data communicated between the UE 102 and base station 104. In further implementations, after performing the RRC connection establishment procedure or security activation procedure, the base station 104 performs a radio bearer configuration procedure with the UE 102 to configure an SRB2 and/or a DRB for the UE 102.

After performing the RRC connection establishment procedure, security activation procedure or radio bearer configuration procedure, the base station 104 transmits 536, 538, to the UE 102 via the TRP 107-1, an RRC reconfiguration message (e.g., RRCReconfiguration message) including a channel state information (CSI) resource configuration and a CSI reporting configuration. In response, the UE 102 transmits 540, 542 an RRC reconfiguration complete message (e.g., RRCReconfigurationComplete message) to the base station 104 via the TRP 107-1. In some implementations, the CSI resource configuration includes configuration parameters configuring channel state information reference signal(s) (CSI-RS(s)) for the UE 102 to measure. The base station 104 transmits the CSI-RS(s) via the TRP 107-2 in accordance with the CSI resource configuration. The UE 102 performs measurements on the CSI-RS(s) in accordance with the CSI resource configuration. In some implementations, the CSI resource configuration includes configuration parameters configuring SSB(s) for the UE 102 to measure. The base station 104 transmits the SSB(s) via the TRP 107-2. The UE 102 performs measurements on the SSB(s) in accordance with the CSI resource configuration. In other implementations, the RRC reconfiguration message or CSI resource configuration does not include configuration parameters configuring SSB(s). In some such cases, the base station 104 still transmits SSB(s) via the TRP 107-2, and the UE 102 performs measurements on the SSB(s). Based on the CSI reporting configuration, the UE 102 generates CSI report(s) from the measurements of the CSI-RS(s) or the SSB(s) and transmits 544, 546 the CSI report(s) to the base station 104 via the TRP 107-1. In some implementations, the UE 102 transmits the CSI report(s) on a PUCCH to the base station 104 via the TRP 107-1. In some implementations, the CSI reporting configuration configures a periodic or semi-persistent reporting, or the CSI reporting configuration configures a semi-persistent or aperiodic reporting triggered by a DCI. The CSI report(s) include periodic CSI report(s), semi-persistent CSI report(s), and/or aperiodic CSI report(s).

In some implementations, the base station 104 includes the CSI resource configuration and/or the CSI report configuration in a CSI measurement configuration (e.g., CSI-MeasConfig IE). The base station 104 then includes the CSI measurement configuration in the RRC reconfiguration message of events 536, 538. In other implementations, the CSI resource configuration includes NZP-CSI-RS-Resource IE(s), NZP-CSI-RS-ResourceSet IE(s), CSI-SSB-ResourceSet IE(s), CSI-ResourceConfig IE(s), and/or CSI-ReportConfig IE(s).

The blocks 536, 538, 540, 542, 544, and 546 are collectively referred to in FIG. 5A as a CSI resource configuration and CSI reporting procedure 594.

After receiving the CSI report(s) at event 546, the base station 104 determines to communicate with the UE 102 via the TRP 107-2 based on the CSI report(s) while maintaining the link with the UE 102 via the TRP 107-1. In some implementations, the base station 104 makes the determination based on one or more capabilities of the UE 102. In response to the determination, the base station 104 transmits 548, 550, to the UE 102 via the TRP 107-1, an RRC reconfiguration message that includes DL and UL configuration parameters for DL and UL communication with the base station 104 via TRP 107-2, respectively. In some implementations, the base station 104 includes the DL and UL configuration parameters in a CellGroupConfig IE and includes the CellGroupConfig IE in the RRC reconfiguration message. In some implementations, the base station 104 includes the DL configuration parameters in a bandwidth part (BW) IE, such as a BWP-DownlinkDedicated IE, and includes the BWP-DownlinkDedicated IE in the RRC reconfiguration message. In some implementations, the base station 104 includes the UL configuration parameters in a BWP-UplinkDedicated IE and includes the BWP-UplinkDedicated IE in the RRC reconfiguration message.

In response to the RRC reconfiguration complete message, the UE 102 transmits 552, 554 an RRC reconfiguration complete message to the base station 104 via the TRP 107-1. In some implementations, the UF 102 applies the DL configuration parameters upon receiving the RRC reconfiguration message at event 554. In such implementations, the UE 102 performs 556 DL communication with the base station 104 via the TRP 107-2 in accordance with the DL configuration parameters, while performing DL and UL communications with the base station 104 via TRP 107-1. In some implementations, the UE 102 refrains from performing UL communication in accordance with the UL configuration parameters until after performing the random access procedure with the base station 104 via the TRP 107-2 at event 598. In further implementations, the UE 102 refrains from performing DL communication with the base station 104 via the TRP 107-2 until after performing the random access procedure with the base station 104 via the TRP 107-2 at event 598. In some implementations, the base station 104 refrains from performing UL communication and/or configuring the UL configuration parameters until after the random access procedure with the base station 104 via the TRP 107-2 at event 598 is completed. In some implementations, the base station 104 refrains from performing DL communication and/or configuring the DL configuration parameters until after the random access procedure with the base station 104 via the TRP 107-2 at event 598 is completed.

In some implementations, the base station 104 and UE 102 use a HARQ entity in FIG. 4A, 4B, or 4C to perform DL communication with the base station 104 via the TRP 107-1 and TRP 107-2 at event 556. In some cases, such as with the HARQ entity 400B of FIG. 4B, the DL configuration parameters of events 548, 550 include HARQ configuration parameters. The HARQ configuration parameters configure a first set of HARQ process IDs and a second set of HARQ process IDs. In some cases, the first set of HARQ process IDs and the second set of HARQ process IDs are for the TRP 107-1 and the TRP 107-2, respectively. The first set of HARQ process IDs and second set of HARQ process IDs identify a first set of HARQ processes of the HARQ entity and a second set of HARQ processes of the HARQ entity, respectively. In some implementations, none of the first set of HARQ process IDs and second set of HARQ process IDs are identical. In other implementations, some of the first set of HARQ process IDs and second set of HARQ process IDs are identical and the others are different.

In some implementations, the base station 104 transmits, to the UE 102, one or more MAC control elements (CEs) or DCIs to change or update one or more HARQ process IDs in the first set of HARQ process IDs. In some implementations, the base station 104 transmits, to the UE 102, one or more MAC CEs or DCIs to change or update one or more HARQ process IDs in the second set of HARQ process IDs. In some alternative implementations, the base station 104 does not configure the first set of HARQ process IDs and second set of HARQ process IDs in the DL configuration parameters. In some implementations, the base station 104 determines the first set of HARQ process IDs and second set of HARQ process IDs for mTRP operation based on a pre-configuration. In further implementations, the first set of HARQ process IDs and second set of HARQ process IDs are specific, pre-determined IDs (e.g., as specified in a 3GPP specification). In yet further implementations, the base station 104 determines the first set of HARQ process IDs and second set of HARQ process IDs based on a rule.

In some implementations, when the base station 104 determines to schedule the UE 102 to receive a DL transmission to the TRP 107-1, the base station 104 selects a HARQ process ID from the first set of HARQ process IDs and transmits a DCI, including a DL assignment, and the selected HARQ process ID to the UE 102. The UE 102 uses a HARQ process identified by the selected HARQ process ID and receives a DL transmission from the base station 104 using the HARQ process and UL grant. Similarly, when the base station 104 determines to schedule the UE 102 to transmit a UL transmission to the TRP 107-2, the base station 104 selects a HARQ process ID from the second set of HARQ process IDs and transmits a DCI, including a UL grant, and the selected HARQ process ID to the UE 102. The UE 102 uses a HARQ process identified by the selected HARQ process ID and receives a DL transmission from the base station 104 using the HARQ process and DL assignment.

In some implementations, the one or more capabilities include at least one first capability indicating that the UE 102 supports mTRP operation (e.g., release 16 capability field(s)/IE(s) and/or release 17 capability field(s)/IE(s) in 3GPP specification 38.306 or 38.331 v17.1.0 or later versions for mTRP operation). In some implementations, the base station 104 determines to configure the DL configuration parameters for DL communication with the base station 104 via the TRP 107-2 based on the at least one first capability. In some implementations, the base station 104 determines the UL configuration parameters for UL communication with the base station 104 via the TRP 107-2 based on the at least one first capability. In cases where the base station 104 includes a DU 174 and a CU 172, the DU 174 makes the determination(s).

In some implementations, the one or more capabilities include at least one second capability. In some such implementations, the at least one second capability indicates that the UE 102 supports multiple UL transmission timings (i.e., operation of two or more TAs) for mTRP operation with a serving cell. In further implementations, the at least one second capability indicates that the UE 102 supports multiple UL transmission timings (for mTRP operation) with a serving cell and a non-serving cell. A Physical Cell Index (PCI) of the non-serving cell is different from a PCI of the serving cell. In some implementations, the least one second capability includes the number of UL transmission timings that the UE 102 support (for mTRP operation) with a serving cell and/or across all serving cell(s) configured/activated for the UE 102. In further implementations, the at least one second capability does not include the number of UL transmission timings (for mTRP operation) and indicates that the UE 102 supports a default number (e.g., 2) of UL transmission timings. In some implementations, the base station 104 determines to configure the UL configuration parameters for UL communication with the base station 104 via the TRP 107-2 based on the at least one second capability. In cases where the base station 104 includes a DU 174 and a CU 172, the DU 174 makes the determination.

In some implementations, the base station 104 receives the one or more capabilities from the UE 102, after receiving the RRC setup complete message or performing the security activation procedure with the UE 102. In some implementations, the base station 104 transmits a UE capability enquiry message (e.g., UECapabilityEnquiry message) to the UE 102 and receives a UE capability information message (e.g., UECapabilityInformation message) including the one or more capabilities from the UE in response.

In other implementations, the base station 104 receives a CN-to-BS message including the one or more capabilities from the CN 110 (e.g., after receiving the RRC setup complete message). In some implementations, the base station 104 transmits a BS-to-CN message to the CN 110 after receiving the RRC setup complete message and the CN 110 transmits the CN-to-BS message after (e.g., in response to) receiving the BS-to-CN message. In some implementations, the UE 102 transmits a NAS message (e.g., Registration Request message or Registration Complete message), including a capability ID identifying the one or more capabilities, to the CN 110, and the CN 110 obtains the one or more capabilities from the capability ID. In other implementations, the UE 102 performs a registration procedure with the CN 110 via a base station (e.g., the base station 104 or 106) before event 502 to register to the CN 110. During the registration procedure, the UE 102 receives a UE capability enquiry message (e.g., UECapabilityEnquiry message) from the base station and transmits a UE capability information message (e.g., UECapabilityInformation message), including the one or more capabilities, to the base station. The base station transmits a BS-to-CN message, including the one or capabilities, to the CN 110, and the CN 110 stores the one or more capabilities. In some implementations, the CN-to-BS message and BS-to-CN messages are NG application protocol (NGAP) messages. In cases where the base station 104 includes a DU 174 and a CU 172, the CU 172 transmits a CU-to-DU message including the one or more capabilities to the DU 174. In some implementations, the CU-to-DU message is an F1 application protocol (F1AP) message.

In some implementations, the base station 104 can include, in the RRC reconfiguration message, random access configuration parameters for the UE 102 to perform 598 the random access procedure. In some implementations, the random access configuration parameters are dedicated to the UE 102. For example, the base station 104 generates a RACH configuration (e.g., RACH-ConfigDedicated, RACH-ConfigDedicated-r18, or RACH-ConfigDedicated-v1800 IE) including the random access configuration parameters dedicated to the UE 102. In some implementations, the format of an RRCReconfiguration message includes ReconfigurationWithSync IE and the ReconfigurationWithSync IE includes a RACH-ConfigDedicated IE (e.g., a RACH configuration or including random access configuration parameters) (e.g., as specified in 3GPP specification 38.331 v17.0.0 or later versions). In cases where the RRC reconfiguration message is an RRCReconfiguration message, the base station 104 includes, in the RRCReconfiguration message, the RACH configuration or the random access configuration parameters for the RRCReconfiguration message, without including a ReconfigurationWithSync IE and wrapping the RACH configuration or the random access configuration parameters in the ReconfigurationWithSync IE. If the base station 104 uses the ReconfigurationWithSync IE to include the random access configuration parameters, the ReconfigurationWithSync IE causes the UE 102 to perform a handover, which causes an interruption in the communication between the UE 102 and the base station 104. In other implementations, the base station 104 refrains from including random access configuration parameters in the RRC reconfiguration message.

In some implementations, the base station 104 indicates that UL synchronization is required in the RRC reconfiguration message (i.e., for communication with the base station 104 over the second TRP). That is, the base station 104 configures the UE 102 to obtain (second) UL synchronization for communication between the UE 102 and TRP 107-1 while maintaining the first UL synchronization for communication between the UE 102 and TRP 107-2. In other words, the base station 104 configures the UE to maintain two TA values for communications between the UE 102 and base station 104 (e.g., between the UE 102 and TRP 107-1 and between the UE 102 and TRP 107-2, respectively). In further implementations, the base station 104 includes, in the RRC reconfiguration message, a configuration (e.g., a field or IE (e.g., RRC Release 18 field or IE)), indicating that UL synchronization is required for communication between the UE 102 and TRP 107-2. In other words, the configuration enables operation of two TA values for communications between the UE 102 and base station 104 (e.g., between the UE 102 and TRP 107-1 and between the UE 102 and TRP 107-2, respectively).

In some implementations, the UE 102 initiates the random access procedure 598 in response to receiving the field or IE, before transmitting UL transmissions (e.g., channel state information (CSI) report, a sounding reference signal (SRS), PUCCH transmissions, and/or PUSCH transmissions) to the base station over the TRP 107-2. In some such implementations, i the RRC reconfiguration message does not include the field or IE, the UE 102 does not initiate a random access procedure and transmits UL transmissions to the base station over the TRP 107-2. In further implementations, the UE 102 refrains from transmitting UL transmissions to the base station over the TRP 107-2 in response to receiving the field or IE. In some such cases, the UE 102 does not transmit a random access preamble to the base station 104 via the TRP 107-2 until receiving a PDCCH order from the base station (e.g., events 558, 560, 559, 561).

The blocks 548, 550, 552, 554, and 556 are collectively referred to in FIG. 5A as a TRP configuration procedure 596A.

In some implementations, after receiving the RRC reconfiguration message at event 538, after performing the CSI resource configuration and CSI reporting procedure 594, or after performing the TRP configuration procedure 596A with the base station 104, the UE 102 receives 562, 564 an RS from the base station 104 via the TRP 107-2. Depending on the implementation, the RS is configured in the CSI resource configuration of event 538, and the events 562, 564 occur after receiving the RRC reconfiguration message at event 538, during or after the CSI resource configuration and CSI reporting procedure 594, or during or after the TRP configuration procedure 596A. After performing the TRP configuration procedure 596A with the base station 104, the UE 102 initiates 598 a random access procedure. In response to initiating the random access procedure, the UE 102 transmits 566, 568 a second random access preamble on a time/frequency resource and a random access channel (RACH) occasion to the base station 104 via the TRP 107-2. In response to the second random access preamble, the base station 104 transmits 570, 572 a second random access response to the UE 102 via the TRP 107-2. The base station 104 includes a second preamble ID and a second TA command in the second random access response. The second preamble ID identifies the second random access preamble, and the second TA command includes a second TA value. The UE applies the second TA value and determines or maintains 574 an uplink synchronized with the TRP 107-2 after (e.g., in response to) applying the second TA value. The UE 102 applies the second TA value to transmit UL transmissions (e.g., PUCCH transmissions, PUSCH transmissions, and/or SRS transmissions) until the UE 102 receives a new or different TA value from base station 104 that updates the second TA value. In some implementations, the UE 102 starts a second TAT to maintain or manage UL synchronization status with the TRP 107-2 or base station 104 after or upon receiving the second TA command. In some implementations, the base station 104 includes a UL grant (e.g., a RAR grant) in the second random access response, and the UE 102 transmits a UL MAC PDU to the base station 104 via the TRP 107-2 in accordance with the UL grant. In cases where the random access procedure is a contention-based random access procedure, the UE 102 includes a C-RNTI of the UE 102 in the UL MAC PDU. The base station 104 identifies the UE 102 based on the C-RNTI. In response to the identification, the base station 104 generates a DCI and a CRC for the DCI, scrambles the CRC with the C-RNTI, and transmits the DCI and scrambled CRC on a PDCCH to the UE 102. In some implementations, the DCI includes n UL grant. Upon receiving the DCI and scrambled CRC on the PDCCH, the UE 102 determines that the content-based random access procedure 598 is performed successfully. In cases where the random access procedure 598 is a contention-free random access procedure, the UE 102 determines that the content-based random access procedure 598 is performed successfully in response to receiving the second random access response message.

In some implementations, the base station 104 starts a second TAT to maintain a second UL synchronization for UL and/or DL communication with the UE 102 via the TRP 107-2 after (e.g., in response to) transmitting the second TA command to the UE 102. In some implementations, the TRP 107-1 generates timing information for the second random access preamble received from the UE 102 and transmits the timing information to the base station 104. As an example, the timing information indicates a propagation delay or a propagation delay shift. Based on the timing information received from the TRP 107-2, the base station 104 determines the second TA value.

The blocks 566, 568, 570, 572, and 574 are collectively referred to in FIG. 5A as a random access procedure 598.

In some implementations, the UE 102 suspends communication (e.g., reception of DL channel/RS or transmission of UL channel/RS) with the base station 104 via the TRP 107-1 while performing the random access procedure 598. Depending on the implementation, the UE 102 does so if the UE 102 is not capable of simultaneously performing a random access procedure based on a UL beam or a RS (i.e., toward a TRP) and communicating UL and DL transmissions (i.e., not related to the random access procedure) based on another UL beam or RS (i.e., toward another TRP). In other implementations, the UE 102 continues communication with the base station 104 via the TRP 107-2 while performing the random access procedure 598. After successfully completing 598 the random access procedure, the UE performs 576 DL and UL communications with the BS via TRP 107-1 and TRP 107-2 in accordance with the first TA value and second TA value, respectively.

In some implementations, the base station 104 and UE 102 use a HARQ entity (e.g., as depicted in FIG. 4A, 4B, or 4C) to perform UL communication with the base station 104 via the TRP 107-1 and TRP 107-2 at event 576. In some cases (e.g., with the exemplary HARQ entity of FIG. 4B), the UL configuration parameters of events 548, 550 include HARQ configuration parameters. The HARQ configuration parameters configure a first set of HARQ process IDs and a second set of HARQ process IDs. In some cases, the first set of HARQ process IDs and the second set of HARQ process IDs are for the TRP 107-1 and TRP 107-2, respectively. The first set of HARQ process IDs and second set of HARQ process IDs identify a first set of HARQ processes of the HARQ entity and a second set of HARQ processes of the HARQ entity, respectively. In some implementations, none of the first set of HARQ process IDs and second set of HARQ process IDs are identical. In other implementations, some of the first set of HARQ process IDs and second set of HARQ process IDs are identical and others are different.

In some implementations, the base station 104 transmits, to the UE 102, one or more MAC CEs or DCIs to change or update one or more HARQ process IDs in the first set of HARQ process IDs. In some further implementations, the base station 104 transmits, to the UE 102, one or more MAC CEs or DCIs to change or update one or more HARQ process IDs in the second set of HARQ process IDs. In some alternative implementations, the base station 104 does not configure the first set of HARQ process IDs and second set of HARQ process IDs in the UL configuration parameters. In some implementations, the base station 104 determines the first set of HARQ process IDs and second set of HARQ process IDs for mTRP operation based on a pre-configuration. In further implementations, the first set of HARQ process IDs and second set of HARQ process IDs are specified sets (e.g., as specified in a 3GPP specification). In yet further implementations, the base station 104 determines the first set of HARQ process IDs and second set of HARQ process IDs based on a rule.

In some implementations, when the base station 104 determines to schedule the UE 102 to transmit a UL transmission to the TRP 107-1, the base station 104 selects a HARQ process ID from the first set of HARQ process IDs and transmits a DCI, including a UL grant, and the selected HARQ process ID to the UE 102. The UE 102 uses a HARQ process identified by the selected HARQ process ID and transmits a UL transmission to the base station 104 using the HARQ process and UL grant. Similarly, when the base station 104 determines to schedule the UE 102 to transmit a UL transmission to the TRP 107-2, the base station 104 selects a HARQ process ID from the second set of HARQ process IDs and transmits a DCI, including a UL grant, and the selected HARQ process ID to the UE 102. The UE 102 uses a HARQ process identified by the selected HARQ process ID and transmits a UL transmission to the base station 104 using the HARQ process and UL grant.

In some implementations, after receiving the RRC reconfiguration complete message at event 554, the base station 104 transmits 558, 560 a PDCCH order to the UE 102 via the TRP 107-2 to cause the UE 102 to initiate the random access procedure 598 with the base station 104 via the TRP 107-2. In some implementations, the PDCCH order includes an RS index and a random access preamble index. Alternatively, the base station 104 transmits the PDCCH order to the UE 102 via the TRP 107-1. In response to the PDCCH order, the UE 102 transmits the random access preamble to the base station 104 via the TRP 107-2 at event 566. In some implementations, the random access preamble index includes a value of the second preamble ID identifying the second random access preamble. Thus, the UE 102 determines the second random access preamble in accordance with the random access preamble index. In other implementations, the random access preamble index includes a value indicating or instructing the UE 102 to determine a random access preamble. Thus, the UE 102 determines the second random access preamble by (randomly) selecting it from the random access preambles configured in the system information.

In some implementations, the PDCCH order is a DCI. The base station 104 generates the DCI and a CRC for the DCI, scrambles the CRC with the C-RNTI, and transmits the DCI and scrambled CRC to the TRP 107-2 (e.g., via a fiber connection). In turn, the TRP 107-2 transmits the DCI and scrambled CRC on a PDCCH to the UE 102. In some implementations, the base station 104 transmits a first packet including the DCI and scrambled CRC to the TRP 107-2. In some implementations, the base station 104 transmits, to the TRP 107-2, control information configuring or indicating time and/or frequency resources for the PDCCH. In some implementations, the time and/or frequency resources include subcarriers, resource elements, or physical resource block(s). The TRP 107-2 transmits the DCI and scrambled CRC on the time and/or frequency resource in accordance with the control information. In some implementations, the base station 104 includes the control information in the first packet. In other implementations, the base station 104 transmits, to the TRP 107-2, a second packet including the control information, instead of the first packet. In other implementations, the base station 104 does not transmit control information for the DCI and scrambled CRC to the TRP 107-2. In such implementations, the TRP 107-2 determines time and/or frequency resources for the PDCCH and transmits the DCI and scrambled CRC on the time and/or frequency resources.

In some implementations, the RS index (e.g., SSB index) identifies one of the SSB(s). In some such implementations, the base station 104 determines or decodes the SSB index indicated in the CSI report(s). In further implementations, the base station 104 determines or decodes the SSB index based on a radio resource (e.g., PUCCH resource) where the base station 104 receives one of the CSI report(s) for the SSB. In some such implementations, the base station 104 configures a different radio resource for the UE 102 to transmit a CSI report for each of the SSB(s). In some examples, the base station 104 includes, in the RRC reconfiguration message of event 536, a configuration configuring a different radio resource (e.g., PUCCH resource) for the UE 102 to transmit a CSI report for each of the SSB(s). In some implementations, the UE 102 determines a time/frequency resource and/or a RACH occasion, based on the SSB (e.g., indicated in the RS index) and the random access configuration parameters received in the system information, and transmits the second random access preamble on the time/frequency resource and/or RACH occasion. In other implementations, the UE 102 determines a time/frequency resource and/or a RACH occasion, based on the SSB (e.g., indicated in the RS index) and the random access configuration parameters received in the RRC reconfiguration message of event 550, and transmits the second random access preamble on the time/frequency resource and/or RACH occasion.

In other implementations, the RS index (e.g., CSI-RS index) identifies one of the CSI-RS(s). In some implementations, the base station 104 determines or decodes the CSI-RS index indicated in the CSI report(s). In further implementations, the base station 104 determines or decodes the CSI-RS index based on a radio resource (e.g., PUCCH resource) where the base station 104 receives the CSI report(s) for the CSI-RS. In some such implementations, the base station 104 configures a different radio resource for the UE 102 to transmit a CSI report for each of the CSI-RS(s). In some examples, the base station 104 includes, in the RRC reconfiguration message of event 536, a configuration configuring a different radio resource (e.g., PUCCH resource) for the UE 102 to transmit a CSI report for each of the CSI-RS(s). In some implementations, the UE 102 determines a time/frequency resource and/or a RACH occasion, based on the CSI-RS (e.g., indicated in the RS index) and the random access configuration parameters in the RRC reconfiguration message that the UE 102 receives at event 550. The UE 102 transmits the second random access preamble on the time/frequency resource and/or RACH occasion. In some implementations, the random access configuration parameters indicate one or more associations between CSI-RS(s), and RACH occasion(s) and/or time/frequency resource(s).

In some implementations, the UE 102 determines transmission characteristics (e.g., spatial transmission filters/parameters) based on or by referring to the RS index in the PDCCH order and transmits the second random access preamble to the TRP 107-2 using the determined transmission characteristics. In some examples, the UE 102 uses reception characteristics for receiving 564 the RS identified by the RS index to derive the transmission characteristics. In some implementations, the transmission characteristics include phase, power, and/or transmission precoder. In some implementations, the UE 102 further uses the DL and/or UL configuration parameters of event 550 to determine the transmission characteristics. In further implementations, the UE 102 uses configuration parameters in the system information of event 510 to determine the transmission characteristics. In some implementations, the UE 102 determines transmission characteristics (e.g., spatial transmission filters/parameters) not based on or not referring to the RS index in the PDCCH order and transmits the second random access preamble to the TRP 107-2 using the determined transmission characteristics.

In some implementations, the UE 102 initiates 598 the random access procedure, in response to the random access configuration parameters received at event 550 and after receiving the RS at event 564. In such implementations, the base station 104 does not transmit the PDCCH order to cause the UE 102 to perform the random access procedure 598.

In some implementations, the RRC reconfiguration message of event 550 includes configuration parameters (e.g., for a PDCCH configuration, search space configuration, and/or control resource set (CORESET) configuration) for the UE 102 to receive DL transmissions from the TRP 107-2. In some implementations, the UE 102 receives the second random access response in accordance with the configuration parameters. In other implementations, the system information of event 510 includes configuration parameters for the UE 102 to receive a random access response from the TRP 107-2. In such implementations, the UE 102 receives the second random access response in accordance with the configuration parameters. In some implementations, the UE 102 uses reception characteristics for receiving 564 the RS to receive the second random access response from the TRP 107-2.

Although the TRP 107-2 is used in the scenario 500A, the above description can be applied to a scenario where the TRP 107-3 is used instead of the TRP 107-2. In such a scenario, after successfully completing a random access procedure with the base station via the TRP 107-3 and cell 125, similar to the procedure 598, the UE performs DL and UL communications with the base station via TRP 107-1 and TRP 107-3 in accordance with the first TA value and second TA value, respectively.

In some scenarios or implementations, the base station 104 transmits, to the UE 102 via the TRP 107-1 or TRP 107-2, a third TA command including a first new TA value to update the first TA value. In some implementations, the third TA command is a MAC control element (CE). The UE 102 applies the first new TA value for the first UL synchronization and restarts the first TAT of the UE 102 in response to receiving the third TA command. The base station 104 restarts the first TAT of the base station 104 in response to transmitting the third TA command. In some scenarios or implementations, the base station 104 transmits, to the UE 102 via the TRP 107-1 or TRP 107-2, a fourth TA command including a second new TA value to update the second TA value. In some implementations, the fourth TA command is a MAC CE. The UE 102 applies the second new TA value for the second UL synchronization and restarts the second TAT in response to receiving the fourth TA command. In some scenarios or implementations, the base station 104 transmits, to the UE 102 via the TRP 107-1 or TRP 107-2, a single TA command including the first new TA value and the second new TA value to update the first TA value and second TA value, respectively. In some implementations, the single TA command is a new or existing MAC control element (CE) (e.g., as defined in 3GPP specification 38.321 V17.1.0).

In some implementations, the TRP 107-1 generates timing information based on UL transmission(s) received from the UE 102 and transmits the timing information to the base station 104. In some examples, the timing information indicates a propagation delay or a propagation delay shift. Based on the timing information received from the TRP 107-1, the base station 104 determines whether to update the first TA value. In some implementations, if the propagation delay or the propagation delay shift is larger than or equal to a first threshold, the base station 104 determines to update the first TA value. Otherwise, if the propagation delay or the propagation delay shift is smaller than a second threshold, the base station 104 determines not to update the first TA value. In some implementations, if the base station 104 determines to update the first TA value, the base station 104 generates the first new TA value. In some implementations, the TRP 107-2 generates timing information based on UL transmission(s) received from the UE 102 and transmits the timing information to the base station 104. In some examples, the timing information indicates a propagation delay or a propagation delay shift. Based on the timing information received from the TRP 107-2, the base station 104 determines whether to update the second TA value. In some implementations, if the propagation delay or the propagation delay shift is larger than or equal to a third threshold, the base station 104 determines to update the second TA value. Otherwise, if the propagation delay or the propagation delay shift is smaller than a fourth threshold, the base station 104 determines not to update the first TA value. In some implementations, if the base station 104 determines to update the second TA value, the base station 104 generates the second new TA value. Depending on the implementation, the first, second, third, and fourth thresholds are the same or different.

Turning to FIG. 5B, a scenario 500B is similar to the scenario 500A, with differences described below. In the scenario 500B, the base station 104 transmits 549, 551, to the UE 102 via the TRP 107-1, an RRC reconfiguration message that includes the DL configuration parameters for DL communication with the base station 104 via the TRP 107-2. In some implementations, the base station 104 includes, in the RRC reconfiguration message, UL configuration parameters for UL communication with the base station 104 via the TRP 107-1 (e.g., to configure or enable DL communication with the base station 104 via the TRP 107-2). In some implementations, the base station 104 includes the DL configuration parameters in a CellGroupConfig IE and includes the CellGroupConfig IE in the RRC reconfiguration message. In some implementations, the base station 104 includes the DL configuration parameters in a BWP-DownlinkDedicated IE and includes the BWP-DownlinkDedicated IE in the RRC reconfiguration message. The RRC reconfiguration message of events 549, 551 is similar to the RRC reconfiguration message of events 548, 550, except that the base station 104 excludes or refrains from including, in the RRC reconfiguration message of events 549, 551, UL configuration parameters for UL communication with the base station 104 via the TRP 107-2. Instead, the base station 104 transmits 578, 580, to the UE 102 via the TRP 107-1, another RRC reconfiguration message that includes the UL configuration parameters for UL communication with the base station 104 via the TRP 107-2. In response, the UE 102 transmits 582, 584 an RRC reconfiguration complete message to the base station 104 via the TRP 107-1. In some implementations, the base station 104 includes the UL configuration parameters in a CellGroupConfig IE and includes the CellGroupConfig IE in the RRC reconfiguration message of events 578, 580. In some implementations, the base station 104 includes the UL configuration parameters in a BWP-UplinkDedicated IE and includes the BWP-UplinkDedicated IE in the RRC reconfiguration message.

The blocks 549, 551, 552, 554, 556, 578, 580, 582, and 584 are collectively referred to in FIG. 5B as a TRP configuration procedure 596B. After receiving the RRC reconfiguration message at event 538, performing the CSI resource configuration and CSI reporting procedure 594, or performing TRP configuration procedure 596B with the base station 104, the UE 102 receives 562, 564 the RS from the base station 104 via the TRP 107-2. After performing the TRP configuration procedure 596A with the base station 104, the UE 102 performs 598 the random access procedure with the base station 104 via the TRP 107-2.

Referring next to FIG. 5C, a scenario 500C is similar to the scenarios 500A and 500B with differences described below.

After transmitting 549, 550 the RRC reconfiguration message or receiving 552, 554 the RRC reconfiguration complete message, the base station 104 transmits 579, 581, to the UE 102 via the TRP 107-2, another RRC reconfiguration message that includes the UL configuration parameters for UL communication with the base station 104 via the TRP 107-2. The RRC reconfiguration message of events 579, 581 are similar to the RRC reconfiguration message of events 578, 580, except that the base station 104 transmits 579, 581 the RRC reconfiguration to the UE 102 via the TRP 107-2 instead of the TRP 107-1.

The blocks 549, 551, 552, 554, 556, 579, 581, 582, and 584 are collectively referred to in FIG. 5C as a TRP configuration procedure 596C.

Referring next to FIG. 5D, a scenario 500D is similar to the scenarios 500A, 500B, and 500C with differences described below.

After the UE 102 performs the TRP configuration procedure 596A, 596B or 596C with the base station 104, the UE 102 initiates 599 a random access procedure. In response to the initiation, the UE 102 transmits 566, 568 the second random access preamble to the base station 104 via TRP 107-2. In response, the base station 104 transmits 571, 573 the second random access response to the UE 102 via the TRP 107-1 instead of the TRP 107-2.

Referring next to FIG. 5E, a scenario 500E is similar to the scenarios 500A, 500B, 500C, and 500D with differences described below.

In some implementations, after receiving the RRC reconfiguration complete message at event 554, the base station 104 transmits 559, 561 a PDCCH order to the UE 102 via the TRP 107-1 to cause the UE 102 to initiate the random access procedure 598 or 599 with the base station 104 via the TRP 107-2, similar to the events 558, 560.

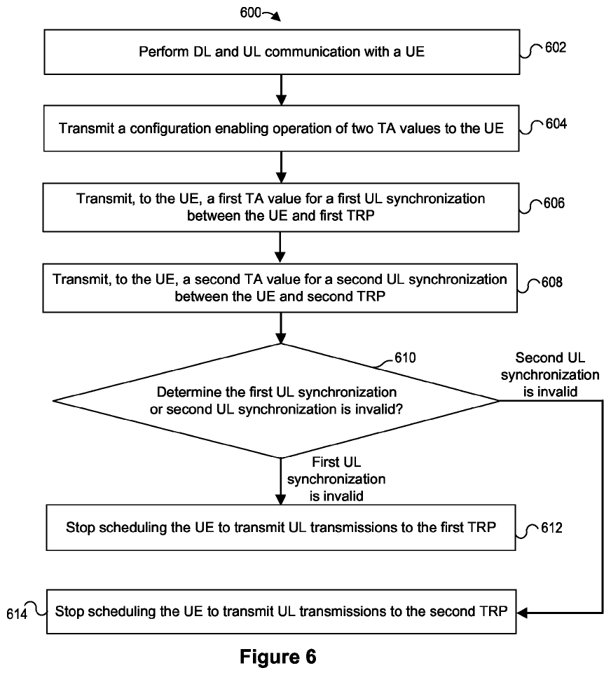

FIGS. 6A-15 are flow diagrams depicting example methods that a RAN node (e.g., the base station 104/106 or a DU 174) implements to enable communication over multiple TRPs for a UE (e.g., the UE 102). In some examples, the first TRP and second TRP described below are the TRP 107-1 and TRP 107-2. In another example, the first TRP and second TRP described below are the TRP 107-1 and TRP 107-3.

Turning to FIG. 6, a RAN node (e.g., the base station 104/106 or DU 174) implements an example method 600 to manage multiple UL synchronizations for communication with a UE (e.g., the UE 102) via multiple TRPs (e.g., TRP 107-1, TRP 107-2, and/or TRP 107-3).

The method 600 begins at block 602, where the RAN node performs DL and UL communications with a UE (e.g., events 504, 506, 508, 510, 512, 514, 516, 518, 590, 522, 524, 526, 528, 532, 534, 592, 536, 538, 540, 542, 544, 546, 594, 549, 551, 552, 554, 556, 562, 564). At block 604, the RAN node transmits, to the UE, a configuration enabling operation of two TA values (e.g., events 548, 550, 596A, 578, 580, 596B, 579, 581, 596C). At block 606, the RAN node transmits, to the UE, a first TA value for a first UL synchronization between the UE and first TRP (e.g., events 516, 518, 590). At block 608, the RAN node transmits, to the UE, a second TA value for a second UL synchronization between the UE and second TRP (e.g., events 570, 572, 598, 571, 573, 599). The flow proceeds to block 610 and/or block 612. At block 610, the RAN node determines whether the first UL synchronization or second UL synchronization is invalid. If the RAN node determines that the first UL synchronization is invalid, the flow proceeds to block 612, where the RAN node stops scheduling the UE to transmit UL transmissions to the first TRP. In some such cases, the RAN continues to schedule the UE to transmit UL transmissions to the second TRP. Otherwise, if the RAN node determines that the second UL synchronization is invalid, the flow proceeds to block 614, where the RAN node stops scheduling the UE to transmit UL transmissions to the second TRP.

In some implementations, the RAN node continues to schedule the UE to transmit UL transmissions to the first TRP at block 614. In some implementations, the RAN node continues to schedule the UE to transmit UL transmissions to the second TRP at block 612. In some implementations, if the RAN node determines both the first and second UL synchronizations are invalid, the RAN node stops scheduling the UE to transmit UL transmissions to the first TRP and stops scheduling the UE to transmit UL transmissions to the second TRP. In some implementation, the UL transmissions above include PUSCH transmissions, SRS transmissions, and/or CSI transmissions.

In some implementations, the RAN node maintains (e.g., manages) a first UL synchronization and a second UL synchronization with the UE by transmitting the first TA value and second TA value to the UE, respectively. In some implementations, the UE applies the first TA value and second TA value to first UL transmissions and second UL transmissions with the RAN node on a serving cell, respectively. In other implementations, the UE applies the first TA value and second TA value to transmit first UL transmissions and second UL transmissions on a serving cell and a non-serving cell with the RAN node, respectively. In some implementations, the non-serving cell is neither a primary cell nor a secondary cell.

In some implementations, the base station transmits the first TA value in a first random access response, a first MAC CE, or a first MAC PDU to UE. In some implementations, the base station transmits the second TA value in a second random access response, a second MAC CE, or a second MAC PDU to the UE. In some implementations, the first MAC CE and second MAC CE are the same MAC CE. In further implementations, the first MAC CE and the second MAC CE are different MAC CEs with the same MAC CE format or different MAC CE formats. In some implementations, the first MAC PDU and second MAC PDU are the same MAC PDU. In further implementations, the first MAC PDU and the second MAC PDU are different MAC PDUs. In some implementations, the RAN node transmits, to the UE, a delta value for the second TA value instead of the second TA value, where the second TA value is equal to the sum of the first TA value and the delta value.

In some implementations, if the first UL synchronization is invalid, the RAN node stops transmitting or scheduling DL transmissions (e.g., PDCCH transmissions and/or PDSCH transmissions) to the UE via the first TRP. In some alternative implementations, if the first UL synchronization is invalid, the RAN node continues transmitting or scheduling DL transmissions to the UE via the first TRP. In some implementations, if the second UL synchronization is invalid, the RAN node stops transmitting or scheduling DL transmissions to the UE via the second TRP. In some alternative implementations, if the second UL synchronization is invalid, the RAN node continues transmitting or scheduling DL transmissions to the UE via the second TRP.

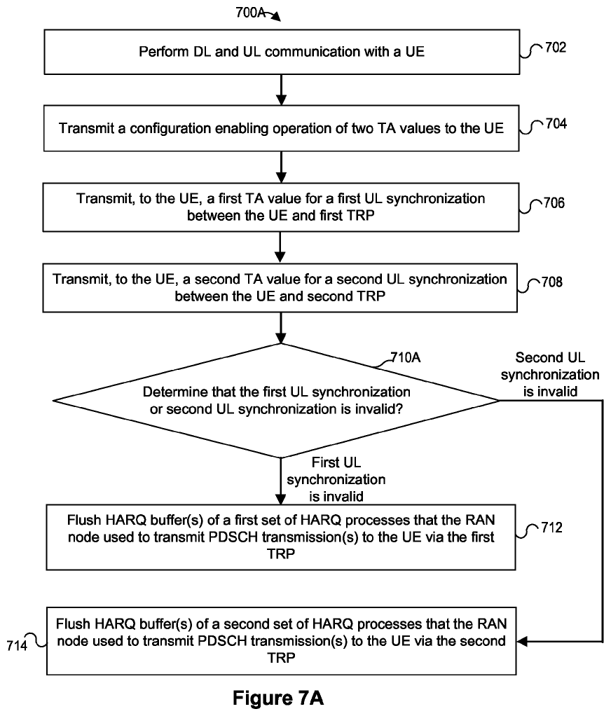

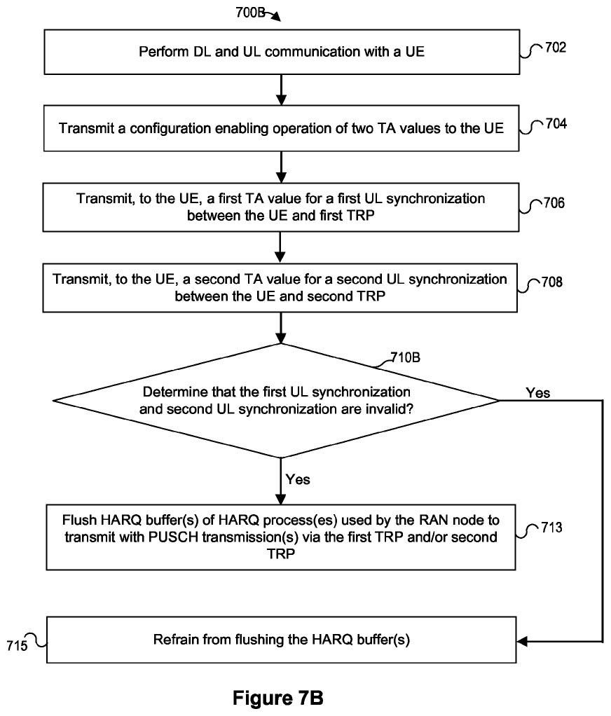

FIG. 7A is a flow diagram of an example method 700A, similar to the method 600 of FIG. 6, where blocks 702-710 are the same as blocks 602-610, respectively. If the RAN node determines that the first UL synchronization is invalid, the flow proceeds to block 712, where the RAN node flushes HARQ buffer(s) of a first set of HARQ processes that the RAN node used to transmit first PDSCH transmission(s) to the UE via the first TRP. Otherwise, if the RAN node determines that the second UL synchronization is invalid, the flow proceeds to block 714, where the RAN node flushes HARQ buffer(s) of a second set of HARQ processes that the RAN node used to transmit second PDSCH transmission(s) to the UE via the second TRP.

In some implementations, the RAN node refrains from flushing the HARQ buffer(s) of the first set of HARQ processes at block 714. In some implementations, the RAN node refrains from flushing the HARQ buffer(s) of the second set of HARQ processes at block 712. In some implementations, if the RAN node determines both the first and second UL synchronizations are invalid, the RAN node flushes HARQ buffer(s) of the first set of HARQ processes and second set of HARQ processes that the RAN node used to transmit the first PDSCH transmission(s) and second PDSCH transmission(s) to the UE via the first TRP and second TRP, respectively.

FIG. 7B is a flow diagram of an example method 700B, similar to the methods 600 and 700A, where blocks 702-708 are the same as blocks 602-608, respectively. At block 711, the RAN node determines whether the first UL synchronization and second UL synchronization are invalid. If the RAN node determines that the first UL synchronization and second UL synchronization are invalid, the flow proceeds to block 713, where the RAN node flushes HARQ buffer(s) of HARQ process(es) used by the RAN node to transmit with PUSCH transmission(s) via the first TRP and/or second TRP. Otherwise, if the RAN node determines that the first UL synchronization and second UL synchronization are valid, or either the first UL synchronization or the second UL synchronization is invalid, the flow proceeds to block 715, where the RAN node refrains from flushing the HARQ buffer(s).

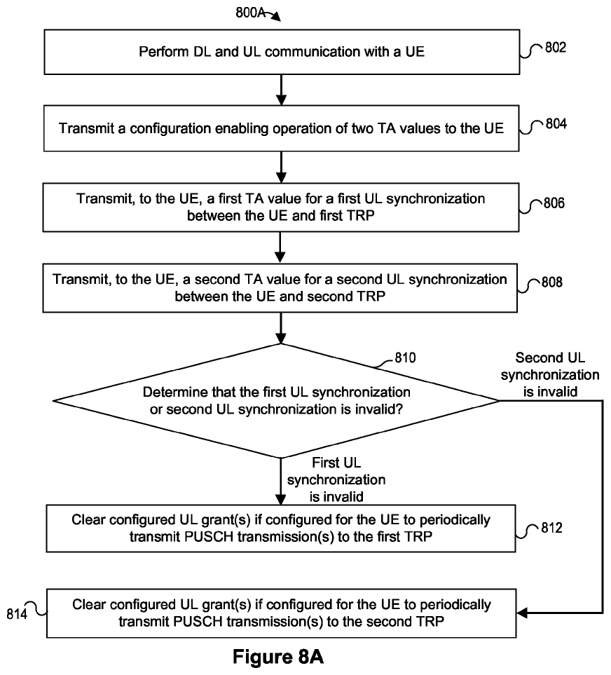

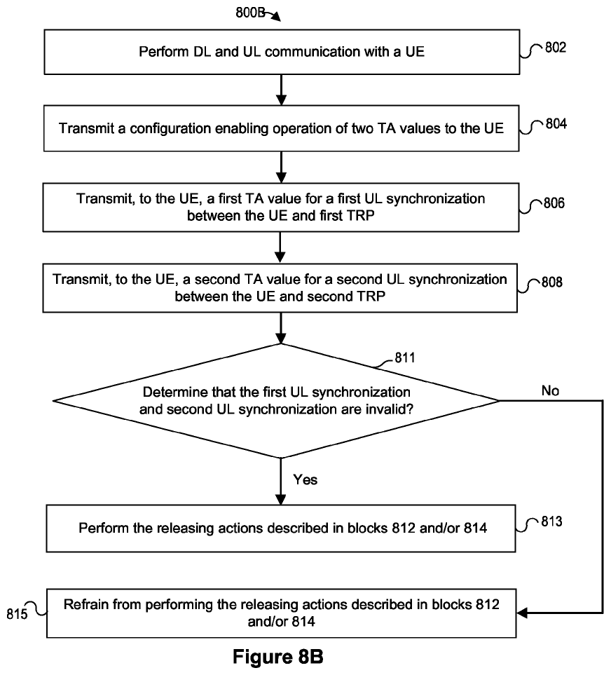

FIG. 8A is a flow diagram of an example method 800A, similar to the method 600 of FIG. 6, where blocks 802-810 are the same as blocks 602-610, respectively. If the RAN node determines that the first UL synchronization is invalid, the flow proceeds to block 812, where the RAN node clears first configured UL grant(s) that are configured for the UE to periodically transmit PUSCH transmission(s) to the first TRP. Otherwise, if the RAN node determines that the second UL synchronization is invalid, the flow proceeds to block 814, where the RAN node clears second configured UL grant(s) that are configured for the UE to periodically transmit PUSCH transmission(s) to the second TRP.

In some implementations, the RAN node refrains from clearing the first configured grant(s) at block 814. In some implementations, the RAN node refrains from clearing the second configured grant(s) at block 812. In some implementations, if the RAN node determines both the first and second UL synchronizations are invalid, the RAN node clears the first configured UL grant(s) and second configured UL grant(s) that are configured for the UE to periodically transmit PUSCH transmission(s) to the first TRP and second TRP, respectively.

In some implementations, the RAN node transmits, to the UE, at least one first configured grant configuration (e.g., ConfiguredGrantConfig IE) configuring the first UL grant(s). In some implementations, the RAN node transmits, to the UE, at least one second configured grant configuration (e.g., ConfiguredGrantConfig IE) configuring the second UL grant(s).

FIG. 8B is a flow diagram of an example method 800B, similar to the methods 600, 700B, and 800A, where blocks 802-811 are the same as blocks 702-711 of FIG. 7B, respectively. If the RAN node determines that the first UL synchronization and second UL synchronization are invalid, the flow proceeds to block 813, where the RAN node performs the clearing actions described in blocks 812 and/or 814. Otherwise, if the RAN node determines that the first UL synchronization and second UL synchronization are valid, or either the first UL synchronization or the second UL synchronization is invalid, the flow proceeds to block 815, where the RAN node refrains from performing the releasing actions described in blocks 812 and/or 814.

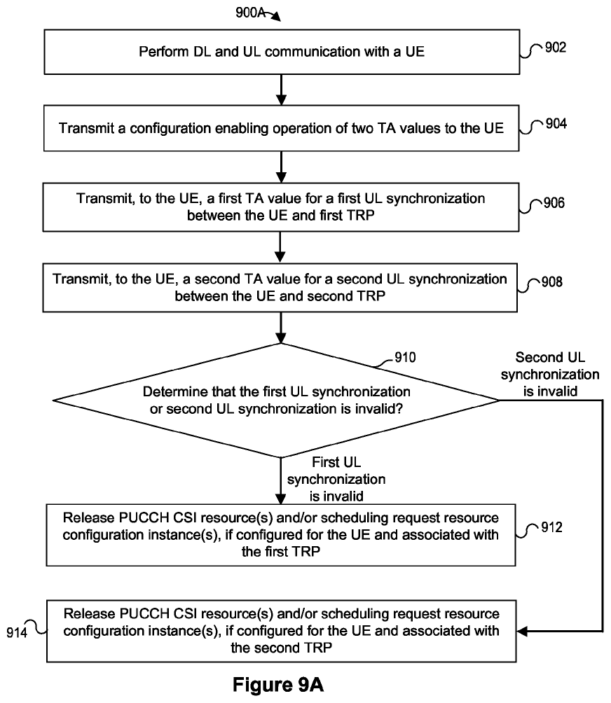

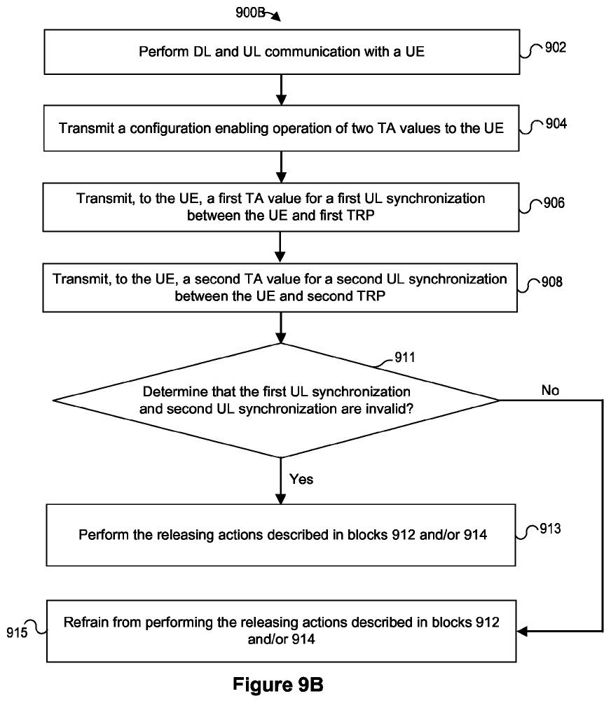

FIG. 9A is a flow diagram of an example method 900A, similar to the method 600 of FIG. 6, where blocks 902-910 are the same as blocks 602-610, respectively. If the RAN node determines that the first UL synchronization is invalid, the flow proceeds to block 912, where the RAN node releases first PUCCH CSI resource(s) and/or first scheduling request resource configuration instance(s) that are configured for the UE and associated with the first TRP. Otherwise, if the RAN node determines that the second UL synchronization is invalid, the flow proceeds to block 914, where the RAN node releases second PUCCH CSI resource(s) and/or second scheduling request resource configuration instance(s) that are configured for the UE and associated with the second TRP.

In some implementations, the RAN node refrains from releasing the first PUCCH CSI resource(s) and/or first scheduling request resource configuration instance(s) at block 914. In some implementations, the RAN node refrains from releasing the second PUCCH CSI resource(s) and/or second scheduling request resource configuration instance(s) at block 912. In some implementations, if the RAN node determines both the first and second UL synchronizations are invalid, the RAN node releases the first PUCCH CSI resource(s) and second PUCCH CSI resource(s) that are configured for the UE and associated with the first TRP and/or second TRP. In some implementations, if the RAN node determines both the first and second UL synchronizations are invalid, the RAN node releases the first and second scheduling request resource configuration instance(s) that are configured for the UE and associated with the first TRP and/or second TRP.

In some implementations, the RAN node transmits, to the UE, at least one first CSI-ReportConfig IE configuring the first PUCCH CSI resource(s). In some implementations, the RAN node transmits, to the UE, at least one second CSI-ReportConfig IE configuring the second PUCCH CSI resource(s). In some implementations, the RAN node transmits, to the UE, at least one first PUCCH-Config IE configuring the first scheduling request resource configuration instance(s). In some implementations, the RAN node transmits, to the UE, at least one second PUCCH-Config IE configuring the second scheduling request resource configuration instance(s).

FIG. 9B is a flow diagram of an example method 900B, similar to the methods 600, 700B, and 900A, where blocks 902-911 are the same as blocks 702-711 of FIG. 7B, respectively. If the RAN node determines that the first UL synchronization and second UL synchronization are invalid, the flow proceeds to block 913, where the RAN node performs the releasing actions described in blocks 912 and/or 914. Otherwise, if the RAN node determines that the first UL synchronization and second UL synchronization are valid, or either the first UL synchronization or the second UL synchronization is invalid, the flow proceeds to block 915, where the RAN node refrains from performing the releasing actions described in blocks 912 and/or 914.

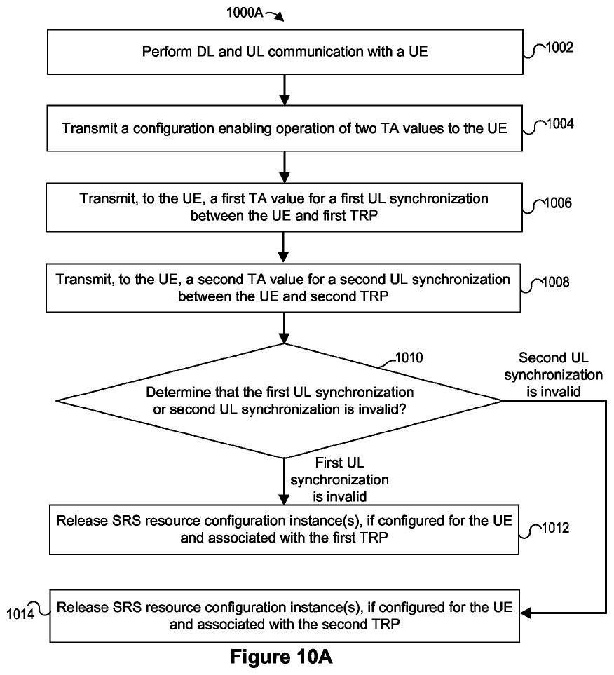

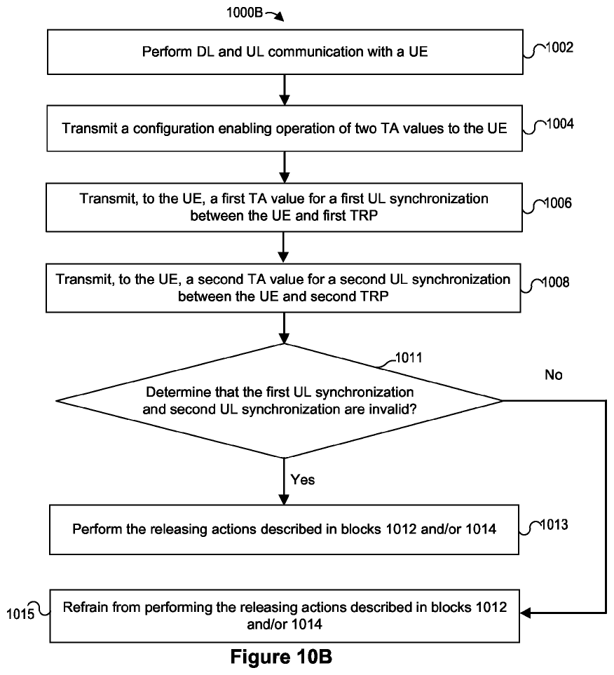

FIG. 10A is a flow diagram of an example method 1000A, similar to the method 600 of FIG. 6, where blocks 1002-1010 are the same as blocks 602-610, respectively. If the RAN node determines that the first UL synchronization is invalid, the flow proceeds to block 1012, where the RAN node releases first SRS resource configuration instance(s) that are configured for the UE and associated with the first TRP. Otherwise, if the RAN node determines that the second UL synchronization is invalid, the flow proceeds to block 1014, where the RAN node releases second SRS resource configuration instance(s) that are configured for the UE and associated with the second TRP.

In some implementations, the RAN node refrains from releasing the first SRS resource configuration instance(s) at block 1014. In some implementations, the RAN node refrains from releasing the second SRS resource configuration instance(s) at block 1012. In some implementations, if the RAN node determines both the first and second UL synchronizations are invalid, the RAN node releases the first SRS resource configuration instance(s) and second SRS resource configuration instance(s) that are configured for the UE and associated with the first TRP and second TRP, respectively.

In some implementations, the RAN node transmits, to the UE, at least one first SRS-Resource IE configuring the first SRS resource configuration instance(s). In some implementations, the RAN node transmits, to the UE, at least one second SRS-Resource IE configuring the second SRS resource configuration instance(s).

FIG. 10B is a flow diagram of an example method 1000B, similar to the methods 600, 700B, and 1000A, where blocks 1002-1011 are the same as blocks 702-711 of FIG. 7B, respectively. If the RAN node determines that the first UL synchronization and second UL synchronization are invalid, the flow proceeds to block 1013, where the RAN node performs the releasing actions described in blocks 1012 and/or 1014. Otherwise, if the RAN node determines that the first UL synchronization and second UL synchronization are valid, or either the first UL synchronization or the second UL synchronization is invalid, the flow proceeds to block 1015, where the RAN node refrains from performing the releasing actions described in blocks 1012 and/or 1014.

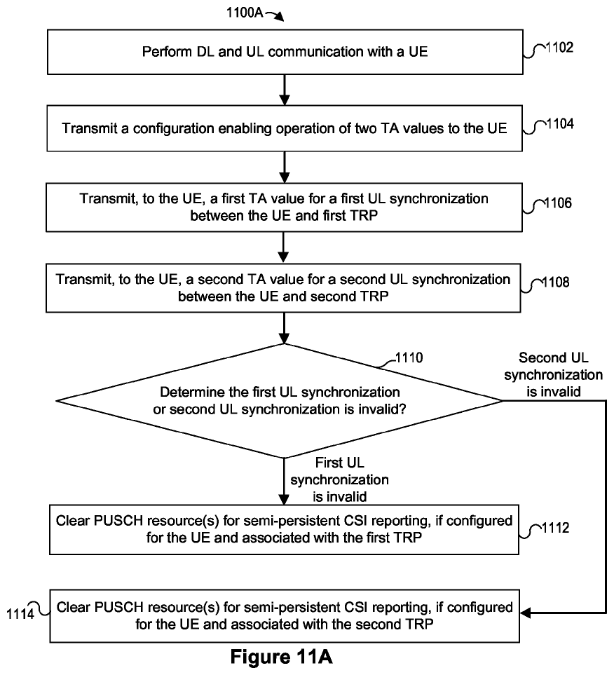

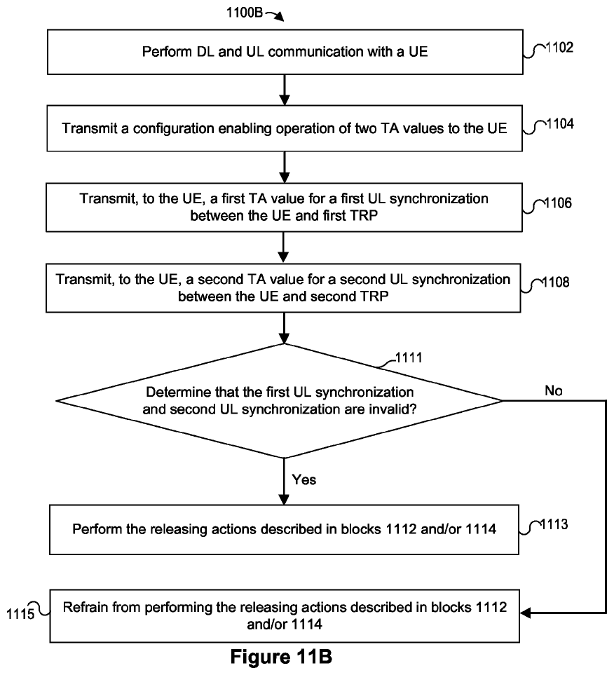

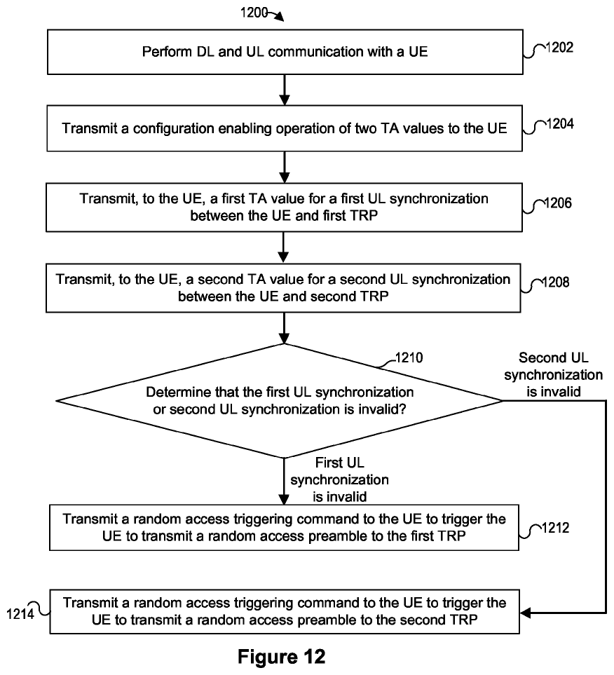

FIG. 11A is a flow diagram of an example method 1100A, similar to the method 600 of FIG. 6, where blocks 1102-1110 are the same as blocks 602-610, respectively. If the RAN node determines that the first UL synchronization is invalid, the flow proceeds to block 1112, where the RAN node clears first PUSCH resource(s) for semi-persistent CSI reporting that are configured for the UE and associated with the first TRP. Otherwise, if the RAN node determines that the second UL synchronization is invalid, the flow proceeds to block 1114, where the RAN node clears second PUSCH resource(s) for semi-persistent CSI reporting that are configured for the UE and associated with the second TRP.

In some implementations, the RAN node refrains from releasing the first PUSCH resource(s) at block 1114. In some implementations, the RAN node refrains from releasing the second PUSCH resource(s) at block 1112. In some implementations, if the RAN node determines both the first and second UL synchronizations are invalid, the RAN node clears the first PUSCH resource(s) and second PUSCH resource(s) that are configured for the UE and associated with the first TRP and second TRP, respectively.

In some implementations, the RAN node transmits, to the UE, at least one first CSI-ReportConfig IE configuring the first PUSCH resource(s). In some implementations, the RAN node transmits, to the UE, at least one second CSI-ReportConfig IE configuring the second PUSCH resource(s).

FIG. 11B is a flow diagram of an example method 1100B, similar to the methods 600, 700B, and 1100A, where blocks 1102-1111 are the same as blocks 702-711 of FIG. 7B, respectively. If the RAN node determines that the first UL synchronization and second UL synchronization are invalid, the flow proceeds to block 1113, where the RAN node performs the releasing actions described in blocks 1112 and/or 1114. Otherwise, if the RAN node determines that the first UL synchronization and second UL synchronization are valid, or either the first UL synchronization or the second UL synchronization is invalid, the flow proceeds to block 1115, where the RAN node refrains from performing the releasing actions described in blocks 1112 and/or 1114.

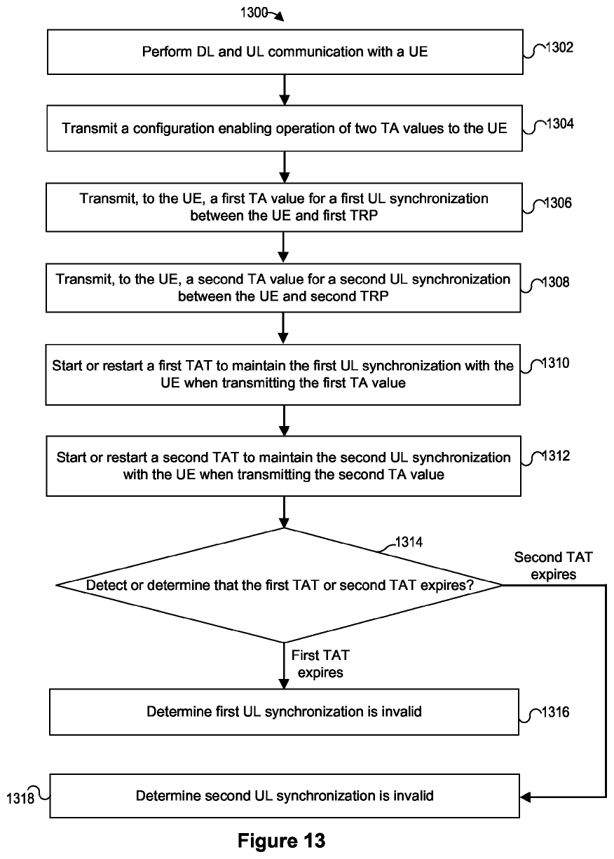

FIG. 12 is a flow diagram of an example method 1200, similar to the method 600 of FIG. 6, where blocks 1202-1210 are the same as blocks 602-610, respectively. If the RAN node determines that the first UL synchronization is invalid, the flow proceeds to block 1212, where the RAN node transmits a random access triggering command to the UE to trigger the UE to transmit a random access preamble to the first TRP. Otherwise, if the RAN node determines that the second UL synchronization is invalid, the flow proceeds to block 1214, where the RAN node transmits a random access triggering command to the UE to trigger the UE to transmit a random access preamble to the second TRP (e.g., events 558, 560, 559, 561).

In some implementations, if the RAN node determines both the first and second UL synchronizations are invalid, the RAN node transmits a random access triggering command to the UE to trigger the UE to transmit a random access preamble to the first TRP. In some such implementations, the RAN node refrains from triggering the UE to transmit a random access preamble to the second TRP.

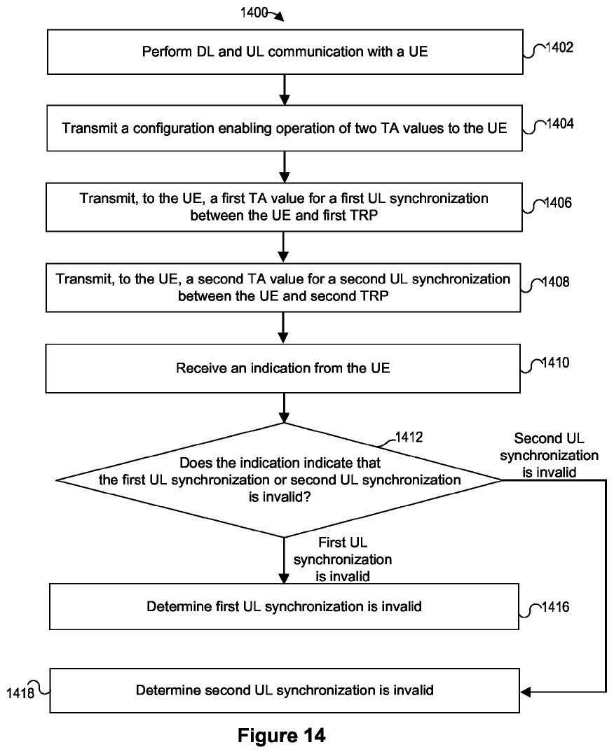

Turning to FIG. 13, a RAN node (e.g., the base station 104/106 or DU 174) implements an example method 1300 to determine whether one of multiple UL synchronizations for communication with a UE (e.g., the UE 102) via multiple TRPs (e.g., TRP 107-1, TRP 107-2, and/or TRP 107-3) is invalid. The example method 1300 can be applied to other embodiments herein (e.g., the embodiments of FIGS. 6-12) to determine whether the first UL synchronization or second UL synchronization is valid.

Blocks 1302-1308 are the same as blocks 602-608 of FIG. 6, respectively. At block 1310, the RAN node starts or restarts a first TAT to maintain the first UL synchronization with the UE when (e.g., upon, after, or in response to) transmitting the first TA value to the UE. At block 1312, the RAN node starts or restarts a first TAT to maintain the second UL synchronization with the UE when transmitting the second TA value to the UE. At block 1314, the RAN node detects or determines whether the first TAT or second TAT expires. If the RAN node detects or determines that the first TAT expires, the flow proceeds to block 1316. At block 1316, the RAN node determines that the first UL synchronization is invalid. Otherwise, if the RAN node detects or determines that the second TAT expires, the flow proceeds to block 1318. At block 1318, the RAN node determines that the second UL synchronization is invalid.

In some implementations, if both the first TAT and second TAT expire, the RAN node determines that the first UL synchronization and second UL synchronization are invalid.

Turning to FIG. 14, a RAN node (e.g., the base station 104/106 or DU 174) implements an example method 1400 to determine whether one of multiple UL synchronizations for communication with a UE (e.g., the UE 102) via multiple TRPs (e.g., TRP 107-1, TRP 107-2, and/or TRP 107-3) is invalid. The example method 1400 can be applied to other embodiments described herein (e.g., the embodiments of FIGS. 6-12) to determine whether the first UL synchronization or second UL synchronization is valid.

Blocks 1402-1408 and blocks 1416-1418 are the same as blocks 602-608 of FIG. 6 and blocks 1316-1318 of FIG. 13, respectively. At block 1410, the RAN node receives an indication from the UE. At block 1412, the RAN node determines whether the indication indicates that the first UL synchronization or second UL synchronization is invalid. If the RAN node determines that the indication indicates that the first UL synchronization is invalid, the flow proceeds to block 1416. Otherwise, if the RAN node determines that the indication indicates that the second UL synchronization is invalid, the flow proceeds to block 1418.

In some implementations, if both the first TAT and second TAT expire, the RAN node determines that the first UL synchronization and second UL synchronization are invalid. In some implementations, the indication is an existing RRC message (e.g., UEAssistanceInformation message) or a new RRC message (e.g., newly defined for indicating a particular UL synchronization is invalid). In other implementations, the indication is a MAC CE. In yet other implementations, the indication is a PUCCH transmission.

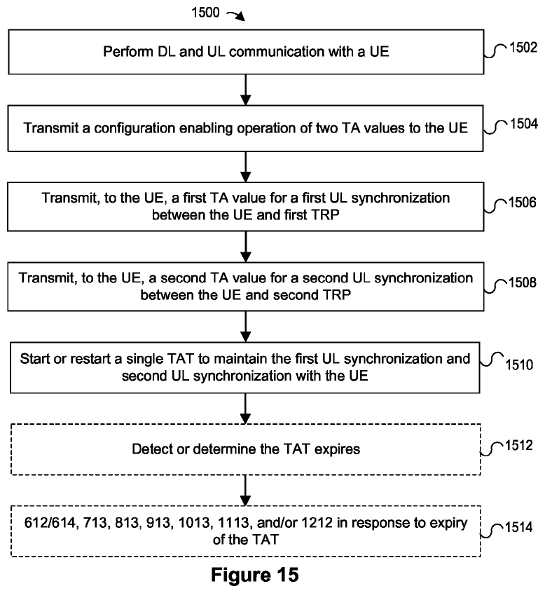

Turning to FIG. 15, a RAN node (e.g., the base station 104/106 or DU 174) implements an example method 1500 to manage multiple UL synchronizations for communication with a UE (e.g., the UE 102) via multiple TRPs (e.g., TRP 107-1, TRP 107-2, and/or TRP 107-3).

Blocks 1502-1508 are the same as blocks 602-608 of FIG. 6, respectively. At block 1510, the RAN node starts or restarts a single TAT to maintain the first UL synchronization and second UL synchronization with the UE. At block 1512, the RAN node detects or determine that the TAT expires. At block 1514, the RAN node performs actions described in blocks 612/614, 713, 813, 913, 1013, 1113, and/or 1212 in response to expiry of the TAT.

In some implementations, the RAN node starts or restarts the single TAT to maintain the first UL synchronization and second UL synchronization with the UE when (e.g., upon, in response to, or after) transmitting or determining to transmit the first TA value, the second TA value, or both the first TA value and second TA value.

Examples and implementations described for FIG. 6 can be applied to FIGS. 7A-15. Similarly, examples and implementations of some embodiments described for FIGS. 6-15 can be applied to other embodiments of FIGS. 6-15 as appropriate.

The following description may be applied to the description above.

Some further implementations or descriptions related to a UE (e.g., UE 102) performing a random access procedure and/or performing multiple-TA operations are described below.

In some implementations, each TRP (e.g., TRP 107-1, TRP 107-2, TRP 107-3, TRP 108-1, and/or TRP 108-2) is associated with or identified by a TRP identifier. In some implementations, a base station (e.g., the base station 104 or 106) includes a TRP identifier in UL configuration(s) that the base station transmits to a UE (e.g., the UE 102) for UL transmission(s) via a TRP identified by the TRP identifier. In some implementations, the UL configuration(s) include DCI transmitted on a PDCCH, and/or PUSCH configuration, PUCCH configuration and/or SRS configuration included in an RRC message (e.g., RRC reconfiguration message or an RRC resume message) that the base station transmits to the UE. In some implementations, the UL transmission(s) include PUSCH transmission(s), PUCCH transmission(s), and/or SRS transmission(s). In some implementations, the base station includes a TRP identifier in DL configuration(s) that the base station transmits to the UE 102 for DL transmission(s) via a TRP identified by the TRP identifier. In some implementations, the DL configuration(s) include DCI transmitted on a PDCCH, and/or CSI resource configuration, PDSCH configuration(s) and/or PDCCH configuration(s) included in an RRC message (e.g., RRC reconfiguration message or an RRC resume message) that the base station transmits to the UE. In some implementations, the DL transmission(s) include CSI-RS transmission(s), SSB transmission(s), PDSCH transmission(s), and/or PDCCH transmission(s).

In other implementations, the base station does not transmit a TRP identifier to the UE and uses an implicit indication to indicate a TRP to the UE. In some implementations, the implicit indication is one of the following configuration parameters: a CORESETPoolIndex, a value or value candidate of a CORESETPoolIndex, a dataScramblingIdentityPDSCH, a dataScramblingIdentityPDSCH2-r16, or a PUCCH-ResourceGroup-r16. In such implementations, the UE derives a TRP (identifier) from the implicit indication. In some implementations, the base station transmits an RRC message (e.g., RRC reconfiguration message or an RRC resume message), including the configuration parameter, to the UE.

In some implementations, the base station configures, for the UE, a first TAG and a second TAG for UL transmissions to the first TRP and second TRP, respectively. In some implementations, the base station transmits, to the UE, a first RRC message and a second RRC message including a first TAG configuration and a second TAG configuration to configure the first TAG and second TAG, respectively. In some implementations, the first TAG configuration and second TAG configuration include a first TAG ID and a second TAG ID to identify the first TAG and second TAG, respectively. In some implementations, the first TAG configuration and second TAG configuration include a timer value of/for the first TAT and a timer value of/for the second TAT for the first TAG and second TAG, respectively. In some implementations, the first RRC message and second RRC message are the same RRC message (e.g., the same instance) or different RRC messages (e.g., different instances or different types of RRC messages). In some implementations, the first and second RRC messages are RRC setup, RRC reconfiguration, and/or RRC resume messages. The UE associates the first TA value and second TA value with the first TAG and second TAG, respectively. In some implementations, the first TAG is associated with the first TRP or the first TRP identifier and/or identifier value. In some implementations, the first TAG is associated with a first serving cell operated by the first TRP and configured for the UE. In some implementations, the first TAG is associated with additional serving cell(s) operated by the first TRP and configured for the UE. In some implementations, the base station indicates or configures the association(s) in the first RRC message. In some implementations, the second TAG is associated with the second TRP or the second TRP identifier and/or identifier value. In some implementations, the second TAG is associated with the first serving cell or non-serving cell, and the base station indicates or configures the association in the second RRC message.

In other implementations, the base station configures, for the UE, a single TAG for UL transmissions to the first TRP and second TRP. In some implementations, the base station transmits, to the UE, a first RRC message (e.g., RRC setup. RRC reconfiguration and/or RRC resume message), including a single TAG configuration to configure the TAG. In some implementations, the TAG configuration includes a single TAG ID to identify the TAG. In some implementations, the TAG configuration includes a timer value of/for the first TAT and a timer value of/for the second. In further implementations, the TAG configuration includes a timer value of/for the first TAT, and the base station transmits a second RRC message (e.g., RRC setup, RRC reconfiguration, and/or RRC resume message), including a timer value of the second TAT. The UE associates the first TA value and second TA value with the TAG. In some implementations, the TAG is associated with (i) the first TRP or the first TRP identifier and/or identifier value and (ii) the second TRP or the second TRP identifier. In some implementations, the TAG is associated with a first serving cell operated by the first TRP and configured for the UE. In some implementations, the TAG is associated with additional serving cell(s) operated by the first TRP and configured for the UE. In some implementations, the base station indicates or configures the association(s) in the first RRC message. In some implementations, the TAG is associated with the second TRP or the second TRP identifier and/or identifier value. In some implementations, the TAG is associated with the first serving cell or non-serving cell, and the base station indicates or configures the association in the second RRC message.

In some implementations, the base station configures that the first serving cell is associated with the first TRP or the first TRP identifier and/or identifier value. In some implementations, the base station configures a first control resource set (CORESET) associated with the first serving cell or first TRP. In further implementations, the base station configures CORESETPoolIndex #0 to identify the first CORESET. In some implementations, the base station transmits, to the UE, a third RRC message (e.g., an RRC setup message, an RRC reconfiguration message, or an RRC resume message) configuring the first CORESET and/or including the CORESETPoolIndex #0. Thus, the UE monitors a PDCCH on the first CORESET to receive DCIs from the base station, which implies that the UE monitors a PDCCH or receives DCIs via the first TRP from the base station (i.e., from the first TRP). In some such cases, the UE determines that CORESETPoolIndex #0 indicates a particular TRP (i.e., the first TRP) of the base station.

In some implementations, the base station configures a first serving cell to be associated with the second TRP or the second TRP identifier and/or identifier value. In other implementation, the second TAG is associated with a non-serving cell, and the base station indicates or configures the association in the second RRC message. In some implementations, the base station configures the non-serving cell associated with the second TRP or the second TRP identifier and/or identifier value. In some implementations, the base station configures a second CORESET to be associated with the first serving cell, non-serving cell, or second TRP. In further implementations, the base station configures CORESETPoolIndex #1 to identify the second CORESET. In some implementations, the base station transmits, to the UE, a third RRC message (e.g., an RRC setup message, an RRC reconfiguration message, or an RRC resume message), configuring the second CORESET and/or including the CORESETPoolIndex #1. Thus, the UE monitors a PDCCH on the second CORESET to receive DCIs from the base station, which implies that the UE monitors a PDCCH or receives DCIs via the second TRP from the base station (i.e., from the second TRP). In some such implementations, the UE determines that CORESETPoolIndex #1 indicates a particular TRP (i.e., the second TRP).

In some implementations, the base station configures a first ID for identifying the first TA value for the UE, in addition to the TAG ID(s) described above. In some implementations, the base station includes the first ID in the RRC message described above. In further implementations, the base station includes the first ID in the first TA command. In other implementations, the UE derives or determines the first ID and associates the first ID with the first TA value. Similarly, the base station configures a second ID for identifying the second TA value for the UE, in addition to the TAG ID(s) described above. In some implementations, the base station includes the second ID in the RRC message described above. In further implementations, the base station includes the second ID in the second TA command. In other implementations, the UE derives or determines the second ID and associates the second ID with the second TA value.

More generally, in some implementations, the base station configures or indicates, to the UE, a first index for or associated with the first TRP. In some implementations, the UE derives or determines the first index. In some implementations, the first index is one of: (i) the first TRP identifier and/or identifier value, (ii) an ID of the first TAG, (iii) an ID of the first TA value, and/or (iv) an ID of the first TAT.

More generally, in further implementations, the base station configures or indicates, to the UE, a second index for/associated with the second TRP. In some implementations, the UE derives the second index. In some implementations, the second index is one of: (i) the second TRP identifier and/or identifier value, (ii) an ID of the second TAG, (iii) an ID of the second TA value, and/or (iv) an ID of the second TAT.

In some implementations, the UE performs one of the following actions: (i) triggering or performing a contention-based or contention-free RA procedure associated with the first index; or (ii) triggering or performing a contention-based or contention-free RA procedure intended for the first TRP, the first TAG, the first TAT or the first TA value.

In some implementations, the UE performs one of the following actions: (i) triggering or performing a contention-based or contention-free RA procedure associated with the second index; or (ii) triggering or performing a contention-based or contention-free RA procedure intended for the second TRP, the second TAG, the second TAT or the second TA value. In some such implementations, some examples include RA procedures including steps of transmitting an RA preamble to the second TRP, as described in at least FIGS. 6, 7A, 7B, 8A, 8B, and 9.

In some implementations, the UE receives, from the base station, a configuration for configuring or indicating a first set of RA resources. In some implementations, the first set of RA resources includes a first set of RA preambles and/or a first set of SSB indices. In further implementations, the first set of RA resources is associated with the first set of SSB indices. In further implementations, the first set of RA resources includes a first set of UL resources and/or grants for transmitting MSG A. In some implementations, the first set of RA resources are associated with or used for the first TRP or the first index. In some implementations, the configuration for configuring or indicating the first set of RA resources includes or is associated with the first index.

In some implementations, the UE receives, from the base station, a configuration for configuring or indicating a second set of RA resources. In some implementations, the second set of RA resources includes a second set of RA preambles and/or a second set of SSB indices. In further implementations, the second set of RA resources is associated with the second set of SSB indices. In further implementations, the second set of RA resources includes a second set of UL resources and/or grants for transmitting MSG A. In some implementations, the second set of RA resources are associated with or used for the second TRP or the second index. In some implementations, the configuration for configuring or indicating the second group of RA resources includes or is associated with the second index.

Some examples of the configuration for configuring or indicating the first group of RA resource include the UL configuration parameters in procedures 596 A/B/C. Some examples of the configuration for configuring or indicating the second group of RA resource include the UL configuration parameters in procedures 596 A/B/C.

In some cases, when or if an RA procedure is associated with or intended for one of: (a) the first index, (b) the first TRP, (c) the first TAG, (d) the first TA value, and/or (e) the first TAT, then at least one of the following is true: (i) the MSG 0 or the PDCCH order (received by the UE from the base station) for the RA procedure indicates or is associated with the first TRP, where, in some implementations, the RA procedure is a contention-free RA procedure; (ii) the MSG 1 or the MSG A (transmitted by the UE to the base station) for the RA procedure indicates or is associated with the first TRP, where, in some implementations, the UE uses the first group of RA resources for transmitting the MSG 1 or MSG A; (iii) the MSG 2 or the MSG B (received by the UE from the base station) for the RA procedure indicates or is associated with the first TRP; (iv) the MSG 3 (transmitted by the UE to the base station) or the MSG 4 (received by the UE from the base station) for the RA procedure indicates or is associated with the first TRP; (v) the MSG 0 or the PDCCH order (received by the UE from the base station) for the RA procedure indicates or is associated with the first index, where, in some implementations, the RA procedure is a contention-free RA procedure; (vi) the MSG 1 or the MSG A (transmitted by the UE to the base station) for the RA procedure indicates or is associated with the first index, where, in some implementations, the UE uses the first group of RA resources for transmitting the MSG 1 or MSG A; (vii) the MSG 2 or the MSG B (received by the UE from the base station) for the RA procedure indicates or is associated with the first index; and/or (viii) the MSG 3 (transmitted by the UE to the base station) or the MSG 4 (received by the UE from the base station) for the RA procedure indicates or is associated with the first index.

In some cases, when or if a RA procedure is associated with or intended for one of: (a) the second index; (b) the second TRP (e.g., for example, RA procedures including steps of transmitting a RA preamble to the second TRP, as described in at least FIGS. 6, 7A, 7B, 8A, 8B, and 9); (c) the second TAG; (d) the second TA value; and/or (e) the second TAT, then at least one of the following is true: (i) the MSG 0 or the PDCCH order (received by the UE from the base station) for the RA procedure indicates or is associated with the second TRP, where, in some implementations, the RA procedure is a contention-free RA procedure; (ii) the MSG 1 or the MSG A (transmitted by the UE to the base station) for the RA procedure indicates or is associated with the second TRP, where, in some implementations, the UE uses the second group of RA resources for transmitting the MSG 1 or MSG A; (iii) the MSG 2 or the MSG B (received by the UE from the base station) for the RA procedure indicates or is associated with the second TRP; (iv) the MSG 3 (transmitted by the UE to the base station) or the MSG 4 (received by the UE from the BS) for the RA procedure indicates or is associated with the second TRP; (v) the MSG 0 or the PDCCH order (received by the UE from the base station) for the RA procedure indicates or is associated with the second index, where, in some implementations, the RA procedure is a contention-free RA procedure; (vi) the MSG 1 or the MSG A (transmitted by the UE to the base station) for the RA procedure indicates or is associated with the second index. where, in some implementations, the UE uses the second group of RA resources for transmitting the MSG 1 or MSG A; (vii) the MSG 2 or the MSG B (received by the UE from the base station) for the RA procedure indicates or is associated with the second index; and/or (viii) the MSG 3 (transmitted by the UE to the base station) or the MSG 4 (received by the UE from the base station) for the RA procedure indicates or is associated with the second index.

Generally speaking, description for one of the above figures can apply to another of the above figures. An event or block described above can be optional or omitted. For example, an event or block with dashed lines in the figures can be optional or omitted. In some cases, an event or block with solid lines in the figures can still be optional or omitted if the event or block is not necessary. In some implementations, blocks in different figures can be combined. In some implementations, “message” is used and can be replaced by “information element (IE)”. In some implementations, “IE” is used and can be replaced by “field”. In some implementations, “configuration” can be replaced by “configurations” or the configuration parameters. In some implementations, “in accordance with” can be replaced by “using”. “mTRP operation” and “mTRP communication” can be interchangeable. In some implementations, “to the base station over the second TRP”, “from the base station over the second TRP”, “with the base station over the second TRP” can be replaced by “to the second TRP”, “from the second TRP”, “with the second TRP”, respectively.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

What is claimed is:

1. A method for managing synchronization, the method implemented in a radio access network (RAN) node and comprising:
transmitting, to a user equipment (UE), a first timing advance (TA) value for managing synchronization of first transmissions between the UE and a first transmission and reception point (TRP) of the RAN node;
transmitting, to the UE, a second TA value for managing synchronization of second transmissions between the UE and a second TRP of the RAN node;
stopping scheduling the first transmissions in response to determining that the synchronization of the first transmissions is invalid; and
stopping scheduling the second transmissions in response to determining that the synchronization of the second transmissions is invalid.

2. The method of claim 1, wherein the determining that the synchronization of the first transmissions is invalid includes:
receiving, from the UE, a notification that a TA timer (TAT) associated with the first TRP has expired.

3. The method of claim 2, wherein the message is a UE assistance information message.

4. The method of claim 2, wherein the message is a dedicated radio resource control message (RRC) message defined for reporting TAT expiration.

5. The method of claim 2, wherein the message is a Media Access Control (MAC) control element (CE).

6. The method of claim 2, wherein the message is a Physical Uplink Control Channel (PUCCH) indication.

7. The method of any of the preceding claims, wherein the first transmissions and the second transmissions include uplink (UL) transmissions.

8. The method of any of the preceding claims, wherein the first transmissions and the second transmissions include downlink (DL) transmissions.

9. The method of any of the preceding claims, further comprising:
subsequently to the stopping of the scheduling of the first transmissions and prior to the stopping of the second transmissions, continuing the scheduling of the second transmissions.

10. The method of any of the preceding claims, wherein:
the first TRP is associated with a first TA group (TAG), and
the second TRP is associated with a second TAG.

11. The method of any of the preceding claims, wherein:
the first TA value is associated with a first TCI state, and
the second TA value is associated with a second TCI state.

12. The method of any of the preceding claims, further comprising:
transmitting, to the UE, an indication that use of multiple TA values is enabled.

13. The method of any of the preceding claims, wherein the transmitting of the first TA value includes:
transmitting a MAC CE including the first TA value.

14. The method of any of claims 1-12, wherein the transmitting of the first TA value includes: transmitting a MAC protocol data unit (PDU) including the first TA value.

15. A radio access network (RAN) comprising:
a transceiver; and
processing hardware configured to implement a method according to any of the preceding claims.
